(19) United States
(12) Patent Application Publication
(10) Pub. No.: US 2025/0011478 A1
(43) Pub. Date: Jan. 9, 2025

(54) SUPPORTED CATALYST SYSTEMS CONTAINING A CARBON BRIDGED, ANTHRACENYL SUBSTITUTED BIS-BIPHENYL-PHENOXY ORGANOMETALLIC COMPOUND FOR MAKING POLYETHYLENE AND POLYETHYLENE COPOLYMER RESINS IN A GAS PHASE POLYMERIZATION REACTOR

(71) Applicant: Dow Global Technologies LLC, Midland, MI (US)

(72) Inventors: Andrew M. Camelio, Auburn, MI (US); Rhett A. Baillie, Missouri City, TX (US); Brad C. Bailey, Midland, MI (US); Johnathan E. DeLorbe, Manvel, TX (US); Hien Q. Do, Pearland, TX (US); David M. Pearson, Lake Jackson, TX (US); Philip P. Fontaine, Pearland, TX (US)

(73) Assignee: Dow Global Technologies LLC, Midland, MI (US)

(21) Appl. No.: 18/710,887

(22) PCT Filed: Nov. 21, 2022
(86) PCT No.: PCT/US2022/050595

§ 371 Date: May 16, 2024

Related U.S. Application Data
(60) Provisional application No. 63/282,448, filed on Nov. 23, 2021.

(51) Int. Cl. C08F 4/659; C08F 2/34; C08F 210/16

(52) U.S. Cl. CPC C08F 4/65916; C08F 2/34; C08F 210/16

(57) ABSTRACT

Embodiments of the present application are directed to supported catalyst systems that include a metal-ligand complex having the structure of formula (I).

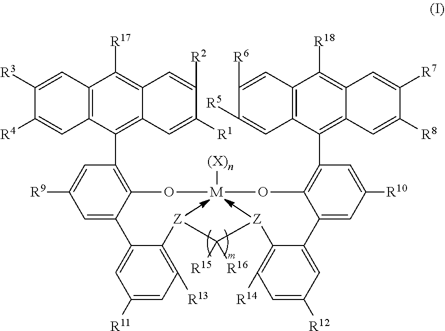

### TECHNICAL FIELD

Embodiments of the present disclosure are generally directed to supported catalyst systems for use in a gas phase polymerization reactor and, in particular, to a supported carbon bridged anthracenyl substituted bis-phenyl-phenoxy catalyst system for use in a gas phase polymerization reactor.

### BACKGROUND

Since the discovery of Ziegler and Natta on heterogeneous olefin polymerizations, global polyolefin production reached approximately 150 million tons per year in 2015, and continues to increase due to market demand. The catalyst systems in the polyolefin polymerization process may contribute to the characteristics and properties of such polyolefins. For example, catalyst systems that include bis-phenyl-phenoxy (BPP) metal-ligand complexes may produce polyolefins that have flat or reverse short-chain branching distributions (SCBD), relatively high levels of comonomer incorporation, high native molecular weights, and/or narrow-medium molecular weight distributions (MWD).

However, when utilized in some polymerization processes, such as gas-phase polymerization, catalyst systems that include BPP metal-ligand complexes may exhibit generally poor productivity. That is, catalyst systems that include BPP metal-ligand complexes may generally produce less polymer relative to the amount of the catalyst system used. Therefore, the use of catalyst systems that include BPP metal-ligand complexes may not be commercially viable in gas-phase polymerization processes.

### SUMMARY

Accordingly, ongoing needs exist for supported catalyst systems that are suitable for use in gas-phase reactors and have improved productivity when utilized in gas-phase polymerization processes. Embodiments of the present disclosure address these needs by providing supported catalyst systems for use in gas-phase polymerization processes, where the supported catalyst system exhibits, among other attributes, a greatly increased productivity when compared to similar catalyst systems including BPP metal-ligand complexes without carbon bridged anthracenyl substituted bis-phenyl-phenoxy catalyst systems of the present disclosure.

Embodiments of the present disclosure include a supported catalyst system in which a metal-ligand complex of formula (I) is disposed on one or more support materials. The metal-ligand complex has a structure according to formula (I):

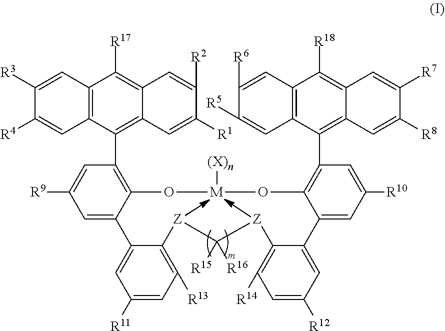

In formula (I), M is titanium, zirconium, or hafnium.

In formula (I) subscript n of (X)ₙ is 1, 2, or 3; each X is a monodentate ligand independently chosen from (C₁-C₅₀)hydrocarbyl, (C₁-C₅₀)heterohydrocarbyl, (C₆-C₅₀)aryl, (C₄-C₅₀)heteroaryl, halogen, —N(R^{N})₂, N(R^{N})COR^{C}, —OR, —OPh, —OAr and —H.

In formula (I), subscript m is 1, 2, 3, 4, or 5.

In formula (I), the metal-ligand complex of formula (I) is overall charge-neutral (prior to being disposed on support materials as discussed herein).

In formula (I), each Z is independently chosen from —O—, —S—, (C₆-C₅₀)aryl, (C₂-C₅₀)heteroaryl, N(C₁-C₅₀)hydrocarbyl, N(C₁-C₅₀)aryl, P(C₁-C₅₀)aryl and P(C₁-C₅₀)hydrocarbyl.

In formula (I), R¹—R⁸ are each independently (C₁-C₂₀)hydrocarbyl, (C₁-C₂₀)heterohydrocarbyl and H.

In formula (I), R⁹ and R¹⁰ are independently chosen from (C₁-C₂₀)hydrocarbyl, (C₁-C₂₀)heterohydrocarbyl and —H.

In formula (I), R¹¹ and R¹² are independently chosen from (C₁-C₂₀)hydrocarbyl, (C₁-C₂₀)heterohydrocarbyl, halogen and —H.

In formula (I), R¹³ and R¹⁴ are independently chosen from (C₁-C₂₀)hydrocarbyl, (C₁-C₂₀)heterohydrocarbyl and —H.

In formula (I), R¹⁵ and R¹⁶ are independently chosen from (C₁-C₂₀)hydrocarbyl, (C₁-C₂₀)heterohydrocarbyl and —H.

In formula (I), R¹⁷ and R¹⁸ are both: (C₁-C₂₀)hydrocarbyl, (C₁-C₂₀) heterohydrocarbyl,

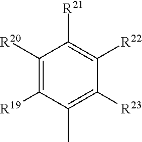

or —H, where R¹⁹⁻²³ are independently chosen from (C₁-C₂₀)hydrocarbyl, (C₁-C₂₀)heterohydrocarbyl and —H.

In some embodiments, at least two R groups of R¹⁹⁻²³ are (C₁-C₂₀)hydrocarbyl. In some embodiments, when R¹¹ and R¹² are halogen, R¹, R⁴, R⁵ and R⁸ are each independently (C₁-C₂₀)hydrocarbyl and R², R³, R⁶ and R⁷ are —H or R¹, R⁴, R⁵ and R⁸ are each —H and R², R³, R⁶ and R⁷ are each independently (C₁-C₂₀)hydrocarbyl.

The supported catalyst system of the present disclosure can also be spray-dried to form a spray-dried supported catalyst system.

The supported catalyst system of the present disclosure can further include one or more activators.

Embodiments of the present disclosure include methods for producing the supported activated metal-ligand catalyst. The method includes contacting one or more support materials and one or more activators with metal-ligand complex (I) in an inert hydrocarbon solvent to produce the supported activated metal-ligand catalyst of formula (Ib):

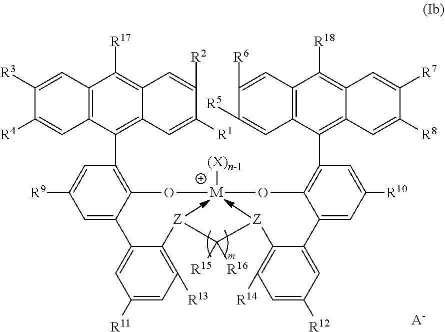

where A⁻ is an anion, and where M; subscript n of (X)ₙ; each X; each subscript m; each Z; R¹, R⁴, R⁵ and R⁸; R², R³, R⁶ and R⁷; R⁹ and R¹⁰; R¹¹ and R¹²; R¹³ and R¹⁴; R¹⁵ and R¹⁶; R¹⁷ and R¹⁸; R, R^{C} and R^{N}; and R¹⁹ through R²³ are as described previously with regard to the metal-ligand complex of formula (I) and formula I(a), as provided herein.

Embodiments of the present disclosure include methods for spray-drying the supported activated metal-ligand catalyst to produce a spray-dried supported activated metal-ligand catalyst, as discussed herein.

Embodiments of the present disclosure include a process for producing a polyethylene or a polyethylene copolymer resin in a gas phase polymerization reactor under effective gas-phase polymerization conditions. The process includes contacting ethylene and, optionally, one or more (C₃-C₁₂)α-olefin comonomers with the supported activated metal-ligand catalyst or spray-dried supported activated metal-ligand catalyst of the present disclosure in a gas phase polymerization reactor under effective gas-phase polymerization conditions.

These and additional features provided by the embodiments of the present disclosure will be more fully understood in view of the following detailed description

### DETAILED DESCRIPTION

Specific embodiments of supported catalyst systems, spray-dried supported catalyst systems, methods of producing supported catalyst systems and spray-dried supported catalyst systems, and processes for producing polyethylene and polyethylene copolymer resins will now be described. However, the systems, methods, and processes of the present disclosure may be embodied in different forms and should not be construed as limited to the specific embodiments set forth in the present disclosure. Rather, embodiments are provided so that the present disclosure will be thorough and complete, and will fully convey the scope of the disclosed subject matter to those skilled in the art.

Common abbreviations used in the present disclosure are listed below:

Me: methyl; Et: ethyl; Ph: phenyl; Bn: benzyl; i-Pr: iso-propyl; t-Bu: tert-butyl; t-Octyl: tert-octyl (2,4,4-trimethylpentan-2-yl); Tf: trifluoromethane sulfonate; THF: tetrahydrofuran; Et₂O: diethyl ether; CH₂Cl₂: dichloromethane; CV: column volume (used in column chromatography); EtOAc: ethyl acetate; C₆D₆: deuterated benzene or benzene-d6; CDCl₃: deuterated chloroform; Na₂SO₄: sodium sulfate; MgSO₄: magnesium sulfate; HCl: hydrogen chloride; n-BuLi: butyllithium; t-BuLi: tert-butyllithium; MeMgBr: methylmagnesium bromide; MAO: methylaluminoxane; MMAO: modified methylaluminoxane; GC: gas chromatography; LC: liquid chromatography; NMR: nuclear magnetic resonance; MS: mass spectrometry; mmol: millimoles; mL: milliliters; M: molar; min or mins: minutes; h or hrs: hours; d: days.

The terms “halogen atom” or “halogen” mean the radical of a fluorine atom (F), chlorine atom (Cl), bromine atom (Br), or iodine atom (I). The term “halide” means the anionic form of the halogen atom: fluoride (F⁻), chloride (Cl⁻), bromide (Br⁻), or iodide (I⁻).

The term “independently selected” means that the R groups, such as, R¹, R², and R³, can be identical or different (e.g., R¹, R², and R³ may all be substituted alkyls; or R¹ and R² may be a substituted alkyl, and R³ may be an aryl). A chemical name associated with an R group is intended to convey the chemical structure that is recognized in the art as corresponding to that of the chemical name. As a result, chemical names are intended to supplement and illustrate, not preclude, the structural definitions known to those of skill in the art.

The term “activator” means a compound that chemically reacts with a neutral metal-ligand complex in a manner that converts this complex to a catalytically active compound. As used in the present disclosure, the terms “co-catalyst” and “activator” are interchangeable and have identical meanings unless clearly specified.

The term “substitution” means that at least one hydrogen atom (—H) bonded to a carbon atom of a corresponding unsubstituted compound or functional group is replaced by a substituent (e.g., R^{S}). The term “—H” means a hydrogen or hydrogen radical that is covalently bonded to another atom. As used in the present disclosure, the terms “hydrogen” and “—H” are interchangeable and have identical meanings unless clearly specified.

When used to describe certain carbon atom-containing chemical groups, a parenthetical expression having the form “(Cₓ-C_{y})” means that the unsubstituted form of the chemical group has from x carbon atoms to y carbon atoms, inclusive of x and y. For example, a (C₁-C₅₀)alkyl is an alkyl group having from 1 to 50 carbon atoms in its unsubstituted form. In some embodiments and general structures, certain chemical groups may be substituted by one or more substituents such as R^{S}. An R^{S} substituted chemical group defined using the “(Cₓ-C_{y})” parenthetical may contain more than y carbon atoms depending on the identity of any groups R^{S}. For example, a “(C₁-C₅₀)alkyl substituted with exactly one group R^{S}, where R^{S} is phenyl (—C₆H₅)” may contain from 7 to 56 carbon atoms. As a result, when a chemical group defined using the “(Cₓ-C_{y})” parenthetical is substituted by one or more carbon atom-containing substituents R^{S}, the minimum and maximum total number of carbon atoms of the chemical group is determined by adding to both x and y the combined sum of the number of carbon atoms from all of the carbon atom-containing substituents R^{S}.

The term “(C₁-C₅₀)hydrocarbyl” means a hydrocarbon radical of from 1 to 50 carbon atoms and the term “(C₁-C₅₀)hydrocarbylene” means a hydrocarbon diradical of from 1 to 50 carbon atoms, in which each hydrocarbon radical and each hydrocarbon diradical is aromatic or non-aromatic, saturated or unsaturated, straight chain or branched chain, cyclic (having three carbons or more, and including mono- and poly-cyclic, fused and non-fused polycyclic, and bicyclic) or acyclic, and substituted by one or more R^{S} or unsubstituted. As used in the present disclosure, a (C₁-C₅₀)hydrocarbyl may be an unsubstituted or substituted (C₁-C₅₀)alkyl, (C₃-C₅₀)cycloalkyl, (C₃-C₂₅)cycloalkyl-(C₁-C₂₅)alkylene, (C₁-C₅₀)aryl, or (C₆-C₂₅)aryl-(C₁-C₂₅)alkylene (such as benzyl (—CH₂-C₆H₅)).

The term “(C₁-C₂₀)hydrocarbyl” means a hydrocarbon radical of from 1 to 20 carbon atoms and the term “(C₁-C₂₀)hydrocarbylene” means a hydrocarbon diradical of from 1 to 20 carbon atoms, in which each hydrocarbon radical and each hydrocarbon diradical is aromatic or non-aromatic, saturated or unsaturated, straight chain or branched chain, cyclic (having three carbons or more, and including mono- and poly-cyclic, fused and non-fused polycyclic, and bicyclic) or acyclic, and substituted by one or more R^{S} or unsubstituted. As used in the present disclosure, a (C₁-C₂₀)hydrocarbyl may be an unsubstituted or substituted (C₁-C₂₀)alkyl, (C₃-C₂₀)cycloalkyl, (C₃-C₂)cycloalkyl-(C₁-C₂₀)alkylene, (C₆-C₂₀)aryl, or (C₆-C₂₀)aryl-(C₁-C₂₀)alkylene (such as benzyl (—CH₂—C₆H₅)).

The term “(C₁-C₅₀)alkyl” means a saturated straight or branched hydrocarbon radical containing from 1 to 50 carbon atoms. Each (C₁-C₅₀)alkyl may be unsubstituted or substituted by one or more R^{S}. In embodiments, each hydrogen atom in a hydrocarbon radical may be substituted with R^{S}, such as, for example, trifluoromethyl. Examples of unsubstituted (C₁-C₅₀)alkyl are unsubstituted (C₁-C₂₀)alkyl; unsubstituted (C₁-C₁₀)alkyl; unsubstituted (C₁-C₅)alkyl; methyl; ethyl; 1-propyl; 2-propyl; 1-butyl; 2-butyl; 2-methylpropyl; 1,1-dimethylethyl; 1-pentyl; 1-hexyl; 1-heptyl; 1-nonyl; and 1-decyl. Examples of substituted (C₁-C₅₀)alkyl are substituted (C₁-C₂₀)alkyl, substituted (C₁-C₁₀)alkyl, trifluoromethyl, and [C₄₅]alkyl. The term “[C₄₅]alkyl” means there is a maximum of 45 carbon atoms in the radical, including substituents, and is, for example, a (C₂₇-C₄₀)alkyl substituted by one R^{S}, which is a (C₁-C₅)alkyl, such as, for example, methyl, trifluoromethyl, ethyl, 1-propyl, 1-methylethyl, or 1,1-dimethylethyl.

The term “(C₃-C₅₀)cycloalkyl” means a saturated cyclic hydrocarbon radical of from 3 to 50 carbon atoms that is unsubstituted or substituted by one or more R^{S}. Other cycloalkyl groups (e.g., (Cₓ-C_{y})cycloalkyl) are defined in an analogous manner as having from x to y carbon atoms and being either unsubstituted or substituted with one or more R^{S}. Examples of unsubstituted (C₃-C₅₀)cycloalkyl are unsubstituted (C₃-C₂₀)cycloalkyl, unsubstituted (C₃-C₁₀)cycloalkyl, cyclopropyl, cyclobutyl, cyclopentyl, cyclohexyl, cycloheptyl, cyclooctyl, cyclononyl, and cyclodecyl. Examples of substituted (C₃-C₅₀)cycloalkyl are substituted (C₃-C₂₀)cycloalkyl, substituted (C₃-C₁₀)cycloalkyl, and 1-fluorocyclohexyl.

The term “(C₁-C₅₀)aryl” means an unsubstituted or substituted (by one or more R^{S}) mono-, bi- or tricyclic aromatic hydrocarbon radical of from 6 to 50 carbon atoms, of which at least from 6 to 14 of the carbon atoms are aromatic ring carbon atoms. A monocyclic aromatic hydrocarbon radical includes one aromatic ring; a bicyclic aromatic hydrocarbon radical has two rings; and a tricyclic aromatic hydrocarbon radical has three rings. When the bicyclic or tricyclyc aromatic hydrocarbon radical is present, at least one of the rings of the radical is aromatic. The other ring or rings of the aromatic radical may be independently fused or non-fused and aromatic or non-aromatic. Examples of unsubstituted (C₆-C₅₀)aryl include: unsubstituted (C₆-C₂₀)aryl, unsubstituted (C₆-C₅₀)aryl; 2-(C₁-C₅)alkyl-phenyl; phenyl; fluorenyl; tetrahydrofluorenyl; indacenyl; hexahydroindacenyl; indenyl; dihydroindenyl; naphthyl; tetrahydronaphthyl; and phenanthrene. Examples of substituted (C₆-C₅₀)aryl include: substituted (C₁-C₂₀)aryl; substituted (C₆-C₁₈)aryl; 2,4-bis([C₂₀]alkyl)-phenyl; polyfluorophenyl; pentafluorophenyl; and fluoren-9-one-1-yl.

The term “—OAr” refers to an oxy linked (C₆-C₂₀)aryl groups and oxy linked (C₂-C₂₀)aryl groups. Such aryl groups can include, but are not limited to, naphthyl, substituted phenyl and naphthyl, furan, thiophene and pyrrole, among others.

The term “heteroatom,” refers to an atom other than hydrogen or carbon. Examples of groups containing one or more than one heteroatom include O, S, S(O), S(O)₂, Si(R^{C})₂. P(R^{P}), N(R^{N}), —N═C(R^{C})₂, —Ge(R^{C})₂—, or —Si(R^{C}) where each R^{C} and each R^{P} is unsubstituted (C₁-C₁₈)hydrocarbyl or —H, and where each R^{N} is unsubstituted (C₁-C₁₈)hydrocarbyl. The term “heterohydrocarbon” refers to a molecule or molecular framework in which one or more carbon atoms of a hydrocarbon are replaced with a heteroatom. The term “(C₁-C₅₀)heterohydrocarbyl” means a heterohydrocarbon radical of from 1 to 50 carbon atoms, and the term “(C₁-C₅₀)heterohydrocarbylene” means a heterohydrocarbon diradical of from 1 to 50 carbon atoms. The heterohydrocarbon of the (C₁-C₅₀)heterohydrocarbyl or the (C₁-C₅₀)heterohydrocarbylene has one or more heteroatoms. The term “(C₁-C₂₀)heterohydrocarbyl” means a heterohydrocarbon radical of from 1 to 20 carbon atoms, and the term “(C₁-C₂)heterohydrocarbylene” means a heterohydrocarbon diradical of from 1 to carbon atoms. The heterohydrocarbon of the (C₁-C₂₀)heterohydrocarbyl or the (C₁-C₂₀)heterohydrocarbylene has one or more heteroatoms. The radical of the heterohydrocarbyl may be on a carbon atom or a heteroatom. The two radicals of the heterohydrocarbylene may be on a single carbon atom or on a single heteroatom. Additionally, one of the two radicals of the diradical may be on a carbon atom and the other radical may be on a different carbon atom; one of the two radicals may be on a carbon atom and the other on a heteroatom; or one of the two radicals may be on a heteroatom and the other radical on a different heteroatom. Each (C₁-C₂₀)heterohydrocarbyl, (C₁-C₂₀)heterohydrocarbylene, (C₁-C₅₀)heterohydrocarbyl and (C₁-C₅₀)heterohydrocarbylene may be unsubstituted or substituted (by one or more R^{S}), aromatic or non-aromatic, saturated or unsaturated, straight chain or branched chain, cyclic (including mono- and poly-cyclic, fused and non-fused polycyclic), or acyclic.

The term “(C₄-C₅₀)heteroaryl” means an unsubstituted or substituted (by one or more R^{S}) mono-, bi-, or tricyclic heteroaromatic hydrocarbon radical of from 4 to 50 total carbon atoms and from 1 to 10 heteroatoms. A monocyclic heteroaromatic hydrocarbon radical includes one heteroaromatic ring; a bicyclic heteroaromatic hydrocarbon radical has two rings; and a tricyclic heteroaromatic hydrocarbon radical has three rings. When the bicyclic or tricyclic heteroaromatic hydrocarbon radical is present, at least one of the rings in the radical is heteroaromatic. The other ring or rings of the heteroaromatic radical may be independently fused or non-fused and aromatic or non-aromatic. Other heteroaryl groups (e.g., (Cₓ-C_{y})heteroaryl generally, such as (C₁-C₄)heteroaryl) are defined in an analogous manner as having from x to v carbon atoms (such as 4 to 12 carbon atoms) and being unsubstituted or substituted by one or more than one R^{S}. The monocyclic heteroaromatic hydrocarbon radical is a 5-membered ring or a 6-membered ring. The 5-membered ring has 5 minus h carbon atoms, wherein h is the number of heteroatoms and may be 1, 2, or 3; and each heteroatom may be O, S, N, or P. Examples of 5-membered ring heteroaromatic hydrocarbon radicals include pyrrol-1-yl; pyrrol-2-yl; furan-3-yl; thiophen-2-yl; pyrazol-1-yl; isoxazol-2-yl; isothiazol-5-yl; imidazol-2-yl; oxazol-4-yl; thiazol-2-yl; 1,2,4-triazol-1-yl; 1,3,4-oxadiazol-2-yl; 1,3,4-thiadiazol-2-yl; tetrazol-1-yl; tetrazol-2-yl; and tetrazol-5-yl. The 6-membered ring has 6 minus h carbon atoms, wherein h is the number of heteroatoms and may be 1 or 2 and the heteroatoms may be N or P. Examples of 6-membered ring heteroaromatic hydrocarbon radicals include pyridine-2-yl; pyrimidin-2-yl; and pyrazin-2-yl. The bicyclic heteroaromatic hydrocarbon radical can be a fused 5,6- or 6,6-ring system. Examples of the fused 5,6-ring system bicyclic heteroaromatic hydrocarbon radical are indol-1-yl; and benzimidazole-1-yl. Examples of the fused 6,6-ring system bicyclic heteroaromatic hydrocarbon radical are quinolin-2-yl; and isoquinolin-1-yl. The tricyclic heteroaromatic hydrocarbon radical can be a fused 5,6,5-, 5,6,6-; 6,5,6-; or 6,6,6-ring system. An example of the fused 5,6,5-ring system is 1,7-dihydropyrrolo[3,2-f]indol-1-yl. An example of the fused 5,6,6-ring system is 1H-benzo[f]indol-1-yl. An example of the fused 6,5,6-ring system is 9H-carbazol-9-yl. An example of the fused 6,5,6- ring system is 9H-carbazol-9-yl. An example of the fused 6,6,6-ring system is acrydin-9-yl.

The terms “polymer” refer to polymeric compounds prepared by polymerizing monomers, whether of the same or a different type. The generic term polymer thus includes homopolymers, which are polymers prepared by polymerizing only one monomer, and copolymers or copolymer resins, which are polymers prepared by polymerizing two or more different types of monomers.

The term “interpolymer” refers to polymers prepared by polymerizing at least two different types of monomers. The generic term interpolymer thus includes copolymers, copolymer resins and other polymers prepared by polymerizing more than two different monomers, such as terpolymers.

The terms “polyolefin,” “polyolefin polymer,” and “polyolefin resin” refer to polymers prepared by polymerizing a simple olefin (also referred to as an alkene, which has the general formula CnH₂ₙ) monomer. The generic term polyolefin thus includes polymers prepared by polymerizing ethylene monomer with or without one or more comonomers, such as polyethylene, and polymers prepared by polymerizing propylene monomer with or without one or more comonomers, such as polypropylene.

The terms “polyethylene” and “ethylene-based polymer” refer to polyolefins comprising greater than 50 percent (%) by mole of units that have been derived from ethylene monomer, which includes polyethylene homopolymers and copolymers. Common forms of polyethylene known in the art include Low Density Polyethylene (LDPE), Linear Low Density Polyethylene (LLDPE), Ultra Low Density Polyethylene (ULDPE), Very Low Density Polyethylene (VLDPE), Medium Density Polyethylene (MDPE), and High Density Polyethylene (HDPE).

The term “molecular weight distribution” means a ratio of two different molecular weights of a polymer. The generic term molecular weight distribution includes a ratio of a weight average molecular weight (M_{w}) of a polymer to a number average molecular weight (Mₙ) of the polymer, which may also be referred to as a “molecular weight distribution (M_{w}/Mₙ),” and a ratio of a z-average molecular weight (M_{z}) of a polymer to a weight average molecular weight (M_{w}) of the polymer, which may also be referred to as a “molecular weight distribution (M_{z}/M_{w}).”

The term “composition” means a mixture of materials that comprises the composition, as well as reaction products and decomposition products formed from the materials of the composition.

The terms “comprising,” “including,” “having,” and their derivatives, are not intended to exclude the presence of any additional component, step, or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step, or procedure, excepting those that are not essential to operability. The term “consisting of” excludes any component, step, or procedure not specifically delineated or listed.

Embodiments of the present disclosure provide for a metal-ligand complex disposed on one or more support materials to provide a supported catalyst system. In particular, embodiments, the present disclosure provides for a supported catalyst system for use in a gas phase polymerization reactor for producing polyethylene from ethylene or, in particular, producing polyethylene copolymer resins from ethylene and one or more (C₃-C₁₂)α-olefin comonomers.

The supported catalyst system of the present disclosure can provide for increased polyethylene and polyethylene copolymer resin productivity and efficiency in gas phase polymerization reactor systems, as seen in the Examples section herein. In addition, the polyethylene and polyethylene copolymer resins produced with the supported catalyst system of the present disclosure can exhibit additional advantageous polymer properties including linear low-to-high density, while also having higher native molecular weights.

Embodiments of the present disclosure include a supported catalyst system in which a metal-ligand complex of formula (I) is disposed on one or more support materials. The metal-ligand complex has a structure according to formula (I):

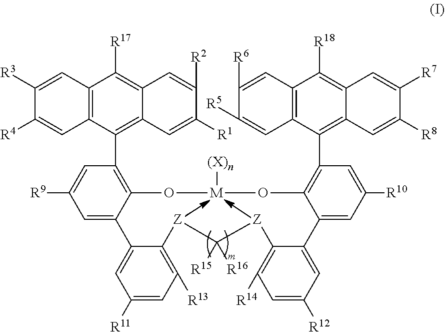

In formula (I), M is titanium (Ti), zirconium (Zr), or hafnium (Hf). In embodiments, M is titanium, zirconium, or hafnium, each independently being in a formal oxidation state of +2, +3, or +4. In a specific embodiment, M is zirconium. In another specific embodiment, M is hafnium.

In formula (I), subscript n of (X)ₙ is 1, 2, or 3, and each X is a monodentate ligand independently chosen from (C₁-C₅₀)hydrocarbyl, (C₁-C₅₀)heterohydrocarbyl, (C₆-C₅₀)aryl, (C₄-C₅₀)heteroaryl, halogen, —N(R^{N})₂, N(R^{N})COR^{C}, —OR, —OPh, —OAr and —H. In embodiments, each X is independently chosen from methyl; ethyl; 1-propyl; 2-propyl; 1-butyl; 2,2,-dimethylpropyl; trimethylsilylmethyl; phenyl; benzyl; or chloro. In or more embodiments, subscript n of (X)ₙ is 2. In some embodiments, subscript n of (X)ₙ is 2 and each X is the same. For example, subscript n of (X)ₙ is 2 and each X is methyl. In other embodiments, at least two X are different. For example, subscript n of (X)ₙ may be 2 and each X may be a different one of methyl; ethyl; 1-propyl; 2-propyl; 1-butyl; 2,2,-dimethylpropyl; trimethylsilylmethyl; phenyl; benzyl; and chloro. In embodiments, subscript n of (X)ₙ is 1 or 2 and at least two X independently are monoanionic monodentate ligands and a third X, if present, is a neutral monodentate ligand.

In formula (I), the metal-ligand complex is overall charge-neutral (prior to being disposed on support materials as discussed herein).

In formula (I), subscript m is 1, 2, 3,4, or 5. In some embodiments, subscript m is 1 to provide, for example, a methylene moiety. In some embodiments, subscript m is 2 to provide, for example, an ethylene moiety. In some embodiments, subscript m of is 3 to provide, for example, a propylene moiety. In some embodiments, subscript m of is 4 to provide, for example, a butylene moiety. In some embodiments, subscript m of is 5 to provide, for example, a pentylene moiety.

In formula (I), each Z is independently chosen from —O—, —S—, (C₆-C₅₀)aryl, (C₂-C₅₀)heteroaryl, N(C₁-C₅₀)hydrocarbyl, N(C₁-C₅₀)aryl, P(C₁-C₅₀)aryl and P(C₁-C₅₀)hydrocarbyl. In embodiments, each Z is the same. For example, each Z is —O—.

In formula (I), R¹—R⁸ are each independently (C₁-C₂₀)hydrocarbyl, (C₁-C₂₀)heterohydrocarbyl and —H. In some embodiments, R¹—R⁸ are each independently (C₁-C₁₀)hydrocarbyl, (C₁-C₁₀)heterohydrocarbyl and —H. In some embodiments, R¹—R⁸ are each independently (C₁-C₅)hydrocarbyl, (C₁-C₅)heterohydrocarbyl and —H. In some embodiments, R¹—R⁸ are each independently chosen from methyl; ethyl; 1-propyl; 2-propyl; n-butyl (butyl); sec-butyl (butan-2-yl), isobutyl (2-methylpropyl), tert-butyl, n-pentyl, tert-pentyl (2-methylbutan-2-yl), neopentyl (2,2-dimethylpropyl), isopentyl (3-methylbutyl), sec-pentyl (pentan-2-yl), 3-pentyl (pentan-3-yl), sec-isopentyl (3-methylbutan-2-yl) and 2-methylbutyl and —H.

In some embodiments, R¹, R⁴, R⁵ and R⁸ are each independently (C₁-C₂₀)hydrocarbyl and R², R³, R⁶ and R⁷ are —H or R¹, R⁴, R⁵ and R⁸ are each —H and R², R³, R⁶ and R⁷ are each independently (C₁-C₂₀)hydrocarbyl. In some embodiments, R¹, R⁴, R⁵ and R⁸ are each independently (C₁-C₁₀)hydrocarbyl and R², R³, R⁶ and R⁷ are —H or R¹, R⁴, R⁵ and R⁸ are each —H and R², R³, R⁶ and R⁷ are each independently (C₁-C₁₀)hydrocarbyl. In some embodiments, R¹, R⁴, R⁵ and R⁸ are each independently (C₁-C₅)hydrocarbyl and R², R³, R⁶ and R⁷ are —H or R¹, R⁴, R⁵ and R⁸ are each —H and R², R³, R⁶ and R⁷ are each independently (C₁-C₅)hydrocarbyl. In some embodiments, R¹, R⁴, R⁵ and R⁸ are each independently chosen from methyl; ethyl; 1-propyl; 2-propyl; n-butyl (butyl); sec-butyl (butan-2-yl), isobutyl (2-methylpropyl), tert-butyl, n-pentyl, tert-pentyl (2-methylbutan-2-yl), neopentyl (2,2-dimethylpropyl), isopentyl (3-methylbutyl), sec-pentyl (pentan-2-yl), 3-pentyl (pentan-3-yl), sec-isopentyl (3-methylbutan-2-yl) and 2-methylbutyl, while R², R³, R⁶ and R⁷ are —H. In some embodiments, R², R³, R⁶ and R⁷ are each independently chosen from methyl; ethyl; 1-propyl; 2-propyl; n-butyl (butyl); sec-butyl (butan-2-yl), isobutyl (2-methylpropyl), tert-butyl, n-pentyl, tert-pentyl (2-methylbutan-2-yl), neopentyl (2,2-dimethylpropyl), isopentyl (3-methylbutyl), sec-pentyl (pentan-2-yl), 3-pentyl (pentan-3-yl), sec-isopentyl (3-methylbutan-2-yl) and 2-methylbutyl, while R¹, R⁴, R⁵ and R⁸ are —H. In some embodiments, R², R³, R⁶ and R⁷ are each (C₄)hydrocarbyl and R¹, R⁴, R⁵ and R⁸ are each —H, where embodiments of the (C₄)hydrocarbyl include n-butyl, sec-butyl, isobutyl and tert-butyl. In some embodiments, R¹, R⁴, R⁵ and R⁸ are each (C₄)hydrocarbyl and R², R³, R⁶ and R⁷ are each —H, where embodiments of the (C₄)hydrocarbyl include n-butyl, sec-butyl, isobutyl and tert-butyl. In some embodiments, R², R³, R⁶ and R⁷ are each tert-butyl and R¹, R⁴, R⁵ and R⁸ are each —H. In some embodiments, R¹, R⁴, R⁵ and R⁸ are each tert-butyl and R², R³, R⁶ and R⁷ are each —H.

In formula (I), R⁹ and R¹⁰ are independently chosen from (C₁-C₂₀)hydrocarbyl, (C₁-C₂₀)heterohydrocarbyl and —H. In some embodiments, R⁹ and R¹⁰ are independently chosen from (C₁-C₁₀)hydrocarbyl, (C₁-C₁₀)heterohydrocarbyl and —H. In some embodiments, each R⁹ and R¹⁰ is independently chosen from methyl; ethyl; 1-propyl; 2-propyl; tert-butyl; 1-butyl; 2,2,-dimethylpropyl; 1,1,-dimethyl,3,3,-dimethylbutyl; cyclopentyl, cyclohexyl, pentyl, 3-methyl-1-butyl, hexyl, 4-methyl-1-pentyl, heptyl, n-octyl, tert-octyl, nonyl, 1,1-dimethyloctyl, and decyl. In some embodiments, each R⁹ and R¹⁰ are the same. For example, each R⁹ and R¹⁰ is 1,1,-dimethyl,3,3,-dimethylbutyl or tert-octyl. In other embodiments, R⁹ and R¹⁰ may be a different one of methyl; ethyl; 1-propyl; 2-propyl; 1-butyl; 2,2,-dimethylpropyl; or 1,1,-dimethyl-3,3,-dimethylbutyl.

In formula (I), R¹¹ and R¹² are independently chosen from (C₁-C₂₀)hydrocarbyl, (C₁-C₂₀)heterohydrocarbyl, halogen and —H. In some embodiments, R¹¹ and R¹² are independently chosen from halogen, (C₁-C₁₀)hydrocarbyl, (C₁-C₁₀)heterohydrocarbyl and —H. In some embodiments, R¹¹ and R¹² are independently chosen from halogen and —H. In embodiments, each R¹¹ and R¹² in formula (I) is a halogen independently selected from the radical of a fluorine atom (F), chlorine atom (C₁), bromine atom (Br), or iodine atom (I). In some embodiments, each R¹¹ and R¹² in formula (I) is the same halogen. For example, R¹¹ and R¹² are fluorine (F).

In formula (I), R¹³ and R¹⁴ are independently chosen from (C₁-C₂₀)hydrocarbyl, (C₁-C₂₀)heterohydrocarbyl and —H. In some embodiments, R¹³ and R¹⁴ are independently chosen from (C₁-C₄)hydrocarbyl, (C₁-C₄)heterohydrocarbyl and —H. In some embodiments, each R¹³ and R¹⁴ is independently chosen from methyl; ethyl; 1-propyl; 2-propyl; n-butyl; sec-butyl, isobutyl and tert-butyl. In some embodiments, each R¹³ and R¹⁴ is the same. For example, each R¹³ and R¹⁴ is methyl. In other embodiments, R¹³ and R¹⁴ may be a different one of methyl; ethyl; 1-propyl; 2-propyl; n-butyl; sec-butyl, isobutyl and tert-butyl.

In formula (I), R¹⁵ and R¹⁶ are independently chosen from (C₁-C₂₀)hydrocarbyl, (C₁-C₂₀)heterohydrocarbyl and —H. In some embodiments, R¹³ and R¹⁴ are independently chosen from (C₁-C₄)hydrocarbyl, (C₁-C₄)heterohydrocarbyl and —H. In some embodiments, each R¹⁵ and R¹⁶ is independently chosen from —H, methyl; ethyl; 1-propyl; 2-propyl; n-butyl; sec-butyl, isobutyl and tert-butyl. In some embodiments, each R¹⁵ and R¹⁶ is the same. For example, each R¹⁵ and R¹⁶ is —H. In other embodiments, R¹⁵ and R¹⁶ may be a different one of —H, methyl; ethyl; 1-propyl; 2-propyl; n-butyl; sec-butyl, isobutyl and tert-butyl.

In formula (I) each R, R^{C} and R^{N} are independently chosen from —H, (C₁-C₅₀)hydrocarbyl, and (C₁-C₅₀)heterohydrocarbyl.

In formula (I), R¹⁷ and R¹⁸ are both: (C₁-C₂₀)hydrocarbyl, (C₁-C₂₀)heterohydrocarbyl,

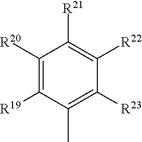

or —H, where R¹⁹⁻²³ are independently chosen from (C₁-C₂₀)hydrocarbyl, (C₁-C₂₀)heterohydrocarbyl and —H. In some embodiments, at least two R groups of R¹⁹⁻²³ are (C₁-C₂₀)hydrocarbyl. The supported catalyst system of the present disclosure can further optionally include a caveat that at least two R groups of R¹⁹⁻²³ are (C₁-C₅)hydrocarbyl. For example, in some embodiments R¹⁷ and R¹⁸ are both:

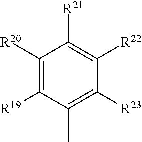

or —H, where R¹⁹⁻²³ are independently chosen from (C₁-C₅)hydrocarbyl and —H with the caveat that at least two R groups of R¹⁹⁻²³ are (C₁-C₅)hydrocarbyl.

In some embodiments, each R¹⁷ and R¹⁸ are both —H. In some embodiments, each R¹⁷ and R¹⁸ are both

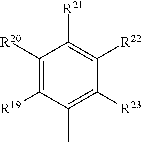

to give the metal-ligand complex a structure according to formula (Ia):

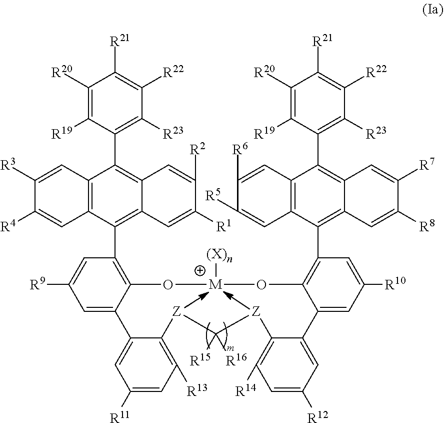

where M; subscript n of (X)ₙ, each X; each subscript m; each Z; R¹, R⁴, R⁵ and R⁸; R², R³, R⁶ and R⁷; R⁹ and R¹⁰; R¹¹ and R¹²; R¹³ and R¹⁴; R¹⁵ and R¹⁶; R¹⁹ through R²³; and R, R^{C} and R^{N} are as described previously with regard to the metal-ligand complex of formula (I). For some embodiments, in formula (Ia) R¹⁹⁻²³ are independently chosen from (C₁-C₂₀)hydrocarbyl, (C₁-C₂₀)heterohydrocarbyl and —H. For some embodiments, in formula (Ia) R¹⁹⁻²³ are independently chosen from (C₁-C₁₀)hydrocarbyl, (C₁-C₁₀)heterohydrocarbyl and —H. For some embodiments, in formula (Ia) R¹⁹⁻²³ are independently chosen from (C₁-C₅)hydrocarbyl, (C₁-C₅)heterohydrocarbyl and —H.

For the given caveat, that at least two R groups of R¹⁹⁻²³ are (C₁-C₂₀)hydrocarbyl, in some embodiments, R²⁰ and R²² are each (C₁-C₂₀)alkyl and R¹⁹, R²¹ and R²³ are each —H. In some embodiments, R²⁰ and R²² are each (C₄)hydrocarbyl and R¹⁹, R²¹ and R²³ are each —H, where embodiments of the (C₄)hydrocarbyl include n-butyl, sec-butyl, isobutyl and tert-butyl. In some embodiments, R¹⁷ and R¹⁸ are both

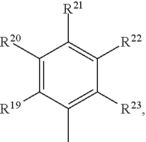

R²⁰ and R²² are each tert-butyl and R¹⁹, R²¹ and R²³ are each —H.

The supported catalyst system of the present disclosure can also be catalytically activated when combined with an activator. In embodiments, the supported catalyst system may be rendered catalytically active by contacting it to, or combining it with, an activator. A supported catalyst system that has been rendered catalytically active by contacting it to, or combining it with, an activator may be referred to as a “supported activated metal-ligand catalyst.” That is, as used in the present disclosure, a supported activated metal-ligand catalyst may include the supported catalyst system of the present disclosure and one or more activators. The term “activator” may include any combination of reagents that increases the rate at which a transition metal compound oligomerizes or polymerizes unsaturated monomers, such as olefins. An activator may also affect the molecular weight, degree of branching, comonomer content, or other properties of the oligomer or polymer. The supported catalyst system of the present disclosure may be activated for oligomerization and/or polymerization catalysis in any manner sufficient to allow coordination or cationic oligomerization and or polymerization.

Alumoxane activators may be utilized as an activator for one or more of the supported catalyst system. Alumoxane(s) or aluminoxane(s) are generally oligomeric compounds containing —Al(R)—O—subunits, where R is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, particularly when the abstractable ligand is a halide. Mixtures of different alumoxanes and modified alumoxanes may also be used. For further descriptions, see U.S. Pat. Nos. 4,665,208; 4,952,540; 5,041,584; 5,091,352; 5,206,199; 5,204,419; 4,874,734; 4,924,018; 4,908,463; 4,968,827; 5,329,032; 5,248,801; 5,235,081; 5,157,137; 5,103,031; and EP 0 561 476; EP 0 279 586; EP 0 516 476; EP 0 594 218; and WO 94/10180.

When the activator is an alumoxane (modified or unmodified), the maximum amount of activator may be selected to be a 5000-fold molar excess Al/M over the supported catalyst system (per metal catalytic site). Alternatively, or additionally the minimum amount of activator-to-supported catalyst system may be set at a 1:1 molar ratio.

Aluminum alkyl or organoaluminum compounds that may be utilized as activators (or scavengers) include trimethylaluminum, triethylaluminum, triisobutylaluminum, tri-n-hexylaluminum, tri-n-octylaluminum and the like.

When the metal-ligand complex is rendered catalytically active by an activator, the metal of the metal-ligand complex may have a formal charge of positive one (+1). For example, in embodiments in which the catalyst system includes the metal-ligand complex, the metal-ligand complex may have a structure according to formula (Ib) and has an overall formal charge of positive one (+1).

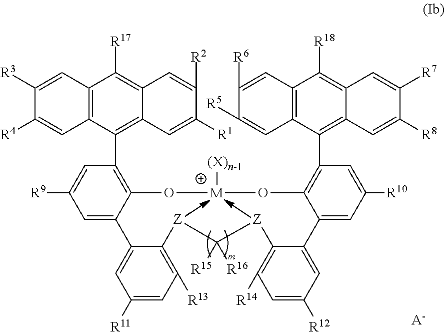

In formula (Ib), A⁻ is an anion, and where M; subscript n of (X)ₙ; each X; subscript m; each Z; R¹, R⁴, R⁵ and R¹; R², R³, R⁶ and R⁷; R⁹ and R¹⁰; R¹¹ and R¹²; R¹³ and R¹⁴; R¹¹ and R¹⁶; R¹⁷ and R¹⁸; R, R^{C} and R^{N}; and R¹⁹ through R²³ are as described previously with regard to the metal-ligand complex of formula (I) and formula I(a).

Formula (Ib) is an illustrative depiction of an activated metal-ligand catalyst.

In embodiments, the metal-ligand complex, the activator, or both, may be disposed on one or more support materials. For example, the metal-ligand complex may be deposited on, contacted with, vaporized with, bonded to, or incorporated within, adsorbed or absorbed in, or on, one or more support materials. The metal-ligand complex may be combined with one or more support materials using one of the support methods well known in the art or as described below. As used in the present disclosure, the metal-ligand complex is in a supported form, for example, when deposited on, contacted with, or incorporated within, adsorbed or absorbed in, or on, one or more support materials.

Suitable support materials, such as inorganic oxides, include oxides of metals of Group 2, 3, 4, 5, 13 or 14 of the IUPAC periodic table (dated 1 Dec. 2018). In embodiments, support materials include silica, which may or may not be dehydrated, fumed silica, alumina (e.g., as described in International Patent Application No. 1999/060033), silica-alumina, and mixtures of these. The fumed silica may be hydrophilic (untreated), alternatively hydrophobic (treated). In embodiments, the support material is hydrophobic fumed silica, which may be prepared by treating an untreated fumed silica with a treating agent, such as dimethyldichlorosilane, a polydimethylsiloxane fluid, or hexamethyldisilazane. In some embodiments, support materials include magnesia, titania, zirconia, magnesium chloride (e.g., as described in U.S. Pat. No. 5,965,477), montmorillonite (e.g., as described in European Patent No. 0 511 665), phyllosilicate, zeolites, talc, clays (e.g., as described in U.S. Pat. No. 6,034,187), and mixtures of these. In other embodiments, combinations of these support materials may be used, such as, for example, silica-chromium, silica-alumina, silica-titania, and combinations of these. Additional support materials may also include those porous acrylic polymers described in European Patent No. 0 767 184. Other support materials may also include nanocomposites described in International Patent Application No. 1999/047598; aerogels described in International Patent Application No. 1999/048605; spherulites described in U.S. Pat. No. 5,972,510; and polymeric beads described in International Patent Application No. 1999/050311.

In embodiments, the support material has a surface area of from 10 square meters per gram (m²/g) to 700 m²/g, a pore volume of from 0.1 cubic meters per gram (cm³/g) to 4.0 cm³/g, and an average particle size of from 5 microns (μm) to 500 μm. In some embodiments, the support material has a surface area of from 50 m²/g to 500 m²/g, a pore volume of from 0.5 cm³/g to 3.5 cm³/g, and an average particle size of from 10 μm to 200 μm. In other embodiments, the support material may have a surface area of from 100 m²/g to 400 m²/g, a pore volume from 0.8 cm³/g to 3.0 cm³/g, and an average particle size of from 5 μm to 100 μm. The average pore size of the support material is typically from 10 Angstroms (Å) to 1,000 Å, such as from 50 Å to 500 Å or from 75 Å to 350 Å.

There are various suitable methods to produce the supported activated metal-ligand catalyst of the present disclosure. In one or more embodiments, methods for producing the supported activated metal-ligand catalyst include contacting one or more support materials and one or more activators with the metal-ligand complex in an inert hydrocarbon solvent to produce the supported activated metal-ligand catalyst. In some embodiments, the method for producing the supported activated metal-ligand catalyst may include disposing the one or more activators on the one or more support materials to produce a supported activator and contacting the supported activator with a solution of the metal-ligand complex in an inert hydrocarbon solvent (often referred to as a “trim catalyst” or a “trim feed”). For example, in some embodiments, methods for producing the supported activated metal-ligand catalyst include contacting a spray-dried supported activator (i.e., a supported activator produced via spray drying) with a solution of the metal-ligand complex in an inert hydrocarbon solvent. In some embodiments, the supported activator may be included in a slurry, such as, for example a mineral oil slurry.

In some embodiments, the method for producing the supported activated metal-ligand catalyst may include mixing one or more support materials, one or more activators, and the metal-ligand complex of the present disclosure to produce a catalyst system precursor. The methods may further include drying the catalyst system precursor to produce the supported activated metal-ligand catalyst. More specifically, the methods may include making a mixture of the metal-ligand complex, one or more support materials, one or more activators, or a combination of these, and an inert hydrocarbon solvent. The inert hydrocarbon solvent may then be removed from the mixture to produce the metal-ligand complex, the one or more activators, or combinations of these, disposed on the one or more support materials. In embodiments, the removing step may be achieved via conventional evaporating of the inert hydrocarbon solvent from the mixture (i.e., conventional concentrating method), which yields a supported activated metal-ligand catalyst. In other embodiments, the removing step may be achieved by spray-drying the mixture, which produces particles of the spray-dried supported activated metal-ligand catalyst. The drying and/or removing steps may not result in the complete removal of liquids from the resulting supported catalyst system. That is, the supported activated metal-ligand catalyst may include residual amounts (i.e., from 1 wt. % to 3 wt. %) of the inert hydrocarbon solvent.

As noted above, the supported activated metal-ligand catalyst of the present disclosure may be utilized in processes for producing polymers, such as polyethylene and polyethylene copolymer resins, via the polymerization of olefins, such as ethylene and, optionally, one or more (C₃-C₁₂)α-olefin comonomers. In embodiments, ethylene, and optionally one or more (C₃-C₁₂)α-olefins, may be contacted with the supported catalyst systems of the present disclosure in a gas-phase polymerization reactor, such as a gas-phase fluidized bed polymerization reactor. Exemplary gas-phase systems are described in U.S. Pat. Nos. 5,665,818; 5,677,375; and 6,472,484; and European Patent Nos. 0 517 868 and 0 794 200. For example, in some embodiments, ethylene and, optionally, one or more (C₃-C₁₂)α-olefin comonomers may be contacted with the supported activated metal-ligand catalyst of the present disclosure in a gas-phase polymerization reactor. The supported activated metal-ligand catalyst may be fed to the gas-phase polymerization reactor in neat form (i.e., as a dry solid), as a solution, or as a slurry. For example, in some embodiments, particles of the spray-dried supported activated metal-ligand catalyst may be fed directly to the gas-phase polymerization reactor. In other embodiments, a solution or slurry of the supported activated metal-ligand catalyst in a solvent, such as an inert hydrocarbon or mineral oil, may be fed to the reactor. For example, the supported catalyst system may be fed to the reactor in an inert hydrocarbon solution and the activator may be fed to the reactor in a mineral oil slurry.

In embodiments, the gas-phase polymerization reactor comprises a fluidized bed reactor. A fluidized bed reactor may include a “reaction zone” and a “velocity reduction zone.” The reaction zone may include a bed of growing polymer particles, formed polymer particles, and a minor amount of the supported catalyst system fluidized by the continuous flow of the gaseous monomer and diluent to remove heat of polymerization through the reaction zone. Optionally, some of the re-circulated gases may be cooled and compressed to form liquids that increase the heat removal capacity of the circulating gas stream when readmitted to the reaction zone. A suitable rate of gas flow may be readily determined by simple experiment. Make up of gaseous monomer to the circulating gas stream may be at a rate equal to the rate at which particulate polymer product and monomer associated therewith may be withdrawn from the reactor and the composition of the gas passing through the reactor may be adjusted to maintain an essentially steady state gaseous composition within the reaction zone. The gas leaving the reaction zone may be passed to the velocity reduction zone where entrained particles are removed. Finer entrained particles and dust may be removed in a cyclone and/or fine filter. The gas may be passed through a heat exchanger where the heat of polymerization may be removed, compressed in a compressor, and then returned to the reaction zone. Additional reactor details and means for operating the reactor are described in, for example, U.S. Pat. Nos. 3,709,853; 4,003,712; 4,011,382; 4,302,566; 4,543,399; 4,882,400; 5,352,749; and 5,541,270; European Patent No. 0 802 202; and Belgian Patent No. 839,380.

In embodiments, the reactor temperature of the gas-phase polymerization reactor is from 30° C. to 150° C. For example, the reactor temperature of the gas-phase polymerization reactor may be from 30° C. to 120° C., from 30° C. to 110° C., from 30° C. to 100° C., from 30° C. to 90° C., from 30° C. to 50° C., from 30° C. to 40° C., from 40° C. to 150° C., from 40° C. to 120° C., from 40° C. to 110° C., from 40° C. to 100° C., from 40° C. to 90° C., from 40° C. to 50° C., from 50° C. to 150° C., from 50° C. to 120° C., from 50° C. to 110° C., from 50° C. to 100° C., from 50° C. to 90° C., from 90° C. to 150° C., from 90° C. to 120° C., from 90° C. to 110° C., from 90° C. to 100° C., from 100° C. to 150° C., from 100° C. to 120° C., from 100° C. to 110° C., from 110° C. to 150° C., from 110° C. to 120° C., or from 120° C. to 150° C. Generally, the gas-phase polymerization reactor may be operated at the highest temperature feasible, taking into account the sintering temperature of the polymer product within the reactor. Regardless of the process used to make the polyethylene or the polyethylene copolymer resin, the reactor temperature should be below the melting or “sintering” temperature of the polymer product. As a result, the upper temperature limit may be the melting temperature of the polymer product.

In embodiments, the reactor pressure of the gas-phase polymerization reactor is from 690 kilopascal (kPa) (100 pounds per square inch gauge, psig) to 3,448 kPa (500 psig). For example, the reactor pressure of the gas-phase polymerization reactor may be from 690 kPa (100 psig) to 2,759 kPa (400 psig), from 690 kPa (100 psig) to 2,414 kPa (350 psig), from 690 kPa (100 psig) to 1,724 kPa (250 psig), from 690 kPa (100 psig) to 1,379 kPa (200 psig), from 1,379 kPa (200 psig) to 3,448 kPa (500 psig), from 1,379 kPa (200 psig) to 2,759 kPa (400 psig), from 1,379 kPa (200 psig) to 2,414 kPa (350 psig), from 1,379 kPa (200 psig) to 1,724 kPa (250 psig), from 1,724 kPa (250 psig) to 3,448 kPa (500 psig), from 1,724 kPa (250 psig) to 2,759 kPa (400 psig), from 1,724 kPa (250 psig) to 2,414 kPa (350 psig), from 2,414 kPa (350 psig) to 3,448 kPa (500 psig), from 2,414 kPa (350 psig) to 2,759 kPa (400 psig), or from 2,759 kPa (400 psig) to 3,448 kPa (500 psig).

In embodiments, hydrogen gas may be used in the gas-phase polymerization to control the final properties of the polyethylene or polyethylene copolymer resin. The amount of hydrogen in the polymerization may be expressed as a mole ratio relative to the total polymerizable monomer, such as, for example, ethylene or a blend of ethylene and 1-hexene. The amount of hydrogen used in the polymerization process may be an amount necessary to achieve the desired properties of the polyethylene or polyethylene copolymer resin, such as, for example, melt flow rate (MFR). In embodiments, the mole ratio of hydrogen to total polymerizable monomer (H₂:monomer) is greater than 0.0001. For example, the mole ratio of hydrogen to total polymerizable monomer (H₂:monomer) may be from 0.0001 to 10, from 0.0001 to 5, from 0.0001 to 3, from 0.0001 to 0.10, from 0.0001 to 0.001, from 0.0001 to 0.0005, from 0.0005 to 10, from 0.0005 to 5, from 0.0005 to 3, from 0.0005 to 0.10, from 0.0005 to 0.001, from 0.001 to 10, from 0.001 to 5, from 0.001 to 3, from 0.001 to 0.10, from 0.10 to 10, from 0.10 to 5, from 0.10 to 3, from 3 to 10, from 3 to 5, or from 5 to 10.

In embodiments, the catalyst systems of the present disclosure may be utilized to polymerize a single type of olefin, producing a homopolymer. However, additional α-olefins may be incorporated into the polymerization scheme in other embodiments. The additional α-olefin comonomers typically have no more than 20 carbon atoms. For example, the catalyst systems of the present disclosure may polymerize ethylene and, optionally, one or more (C₃-C₁₂)α-olefin comonomers in a gas phase reactor to produce a polyethylene or a polyethylene copolymer resin. Exemplary (C₃-C₁₂)α-olefin comonomers include, but are not limited to, propylene, 1-butene, 1-pentene, 1-hexene, 1-heptene, 1-octene, 1-nonene, 1-decene, and 4-methyl-1-pentene. For example, the one or more (C₃-C₁₂)α-olefin co-monomers may be selected from the group consisting of propylene, 1-butene, 1-hexene, and 1-octene; or, in the alternative, from the group consisting of 1-hexene and 1-octene.

In embodiments, the one or more (C₃-C₁₂)α-olefin comonomers, when used, may not be derived from propylene. That is, the one or more (C₃-C₁₂)α-olefin comonomers may be substantially free of propylene. The term “substantially free” of a compound means the material or mixture includes less than 1.0 wt. % of the compound. For example, the one or more (C₃-C₁₂)α-olefin comonomers, which may be substantially free of propylene, may include less than 1.0 wt. % propylene, such as less than 0.8 wt. % propylene, less than 0.6 wt. % propylene, less than 0.4 wt. % propylene, or less than 0.2 wt. % propylene.

In embodiments, the polyethylene produced, for example homopolymers and/or interpolymers (including copolymers) of ethylene and, optionally, one or more comonomers may include at least 50 mole percent (mol. %) monomer units derived from ethylene. For example, the polyethylene may include at least 60 mol. %, at least 70 mol. %, at least 80 mol. %, or at least 90 mol. % monomer units derived from ethylene. In embodiments, the polyethylene includes from 50 mol. % to 100 mol. % monomer units derived from ethylene. For example, the polyethylene may include from 50 mol. % to 90 mol. %, from 50 mol. % to 80 mol. %, from 50 mol. % to 70 mol. %, from 50 mol. % to 60 mol. %, from 60 mol. % to 100 mol. %, from 60 mol. % to 90 mol. %, from 60 mol. % to 80 mol. %, from 60 mol. % to 70 mol. %, from 70 mol. % to 100 mol. %, from 70 mol. % to 90 mol. %, from 70 mol. % to 80 mol. %, from 80 mol. % to 100 mol. %, from 80 mol. % to 90 mol. %, or from 90 mol. % to 100 mol. % monomer units derived from ethylene.

In embodiments, the polyethylene produced includes at least 90 mol. % monomer units derived from ethylene. For example, the polyethylene may include at least 93 mol. %, at least 96 mol. %, at least 97 mol. %, or at least 99 mol. % monomer units derived from ethylene. In embodiments, the polyethylene includes from 90 mol. % to 100 mol. % monomer units derived from ethylene. For example, the polyethylene may include from 90 mol. % to 99.5 mol. %, from 90 mol. % to 99 mol. %, from 90 mol. % to 97 mol. %, from 90 mol. % to 96 mol. %, from 90 mol. % to 93 mol. %, from 93 mol. % to 100 mol. %, from 93 mol. % to 99.5 mol. %, from 93 mol. % to 99 mol. %, from 93 mol. % to 97 mol. %, from 93 mol. % to 96 mol. %, from 96 mol. % to 100 mol. %, from 96 mol. % to 99.5 mol. %, from 96 mol. % to 99 mol. %, from 96 mol. % to 97 mol. %, from 97 mol. % to 100 mol. %, from 97 mol. % to 99.5 mol. %, from 97 mol. % to 99 mol. %, from 99 mol. % to 100 mol. %, from 99 mol. % to 99.5 mol. %, or from 99.5 mol. % to 100 mol. % monomer units derived from ethylene.

In embodiments, the polyethylene copolymer resin produced includes less than 50 mol. % monomer units derived from one or more (C₃-C₁₂)α-olefin comonomers. For example, the polyethylene copolymer resin may include less than 40 mol. %, less than 30 mol. %, less than 20 mol. % or less than 10 mol. % monomer units derived from one or more (C₃-C₁₂)α-olefin comonomers. In embodiments, the polyethylene copolymer resin includes from greater than 0 mol. % to 50 mol. % monomer units derived from one or more (C₃-C₁₂)α-olefin comonomers. For example, the polyethylene copolymer resin may include from greater than 0 mol. % to 40 mol. %, from greater than 0 mol. % to 30 mol. %, from greater than 0 mol. % to 20 mol. %, from greater than 0 mol. % to 10 mol. %, from greater than 0 mol. % to 5 mol. %, from greater than 0 mol. % to 1 mol. %, from 1 mol. % to 50 mol. %, from 1 mol. % to 40 mol. %, from 1 mol. % to 30 mol. %, from 1 mol. % to 20 mol. %, from 1 mol. % to 10 mol. %, from 1 mol. % to 5 mol. %, from 5 mol. % to 50 mol. %, from 5 mol. % to 40 mol. %, from 5 mol. % to 30 mol. %, from 5 mol. % to 20 mol. %, from 5 mol. % to 10 mol. %, from 10 mol. % to 50 mol. %, from 10 mol. % to 40 mol. %, from 10 mol. % to 30 mol. %, from 10 mol. % to 20 mol. %, from 20 mol. % to 50 mol. %, from 20 mol. % to 40 mol. %, from 20 mol. % to 30 mol. %, from 30 mol. % to 50 mol. %, from 30 mol. % to 40 mol. %, or from 40 mol. % to 50 mol. % monomer units derived from one or more (C₃-C₁₂)α-olefin comonomers.

In embodiments, the polyethylene or polyethylene copolymer resin produced further includes one or more additives. Such additives include, but are not limited to, antistatic agents, color enhancers, dyes, lubricants, pigments, primary antioxidants, secondary antioxidants, processing aids, ultraviolet (UV) stabilizers, and combinations of these. The polyethylene or polyethylene copolymer resin may include any amounts of additives. In embodiments, the produced polyethylene or polyethylene copolymer resin further include fillers, which may include, but are not limited to, organic or inorganic fillers, such as, for example, calcium carbonate, talc, or Mg(OH)₂.

The produced polyethylene or polyethylene copolymer resin may be used in a wide variety of products and end-use applications. The produced polyethylene or polyethylene copolymer resin may also be blended and/or co-extruded with any other polymer. Non-limiting examples of other polymers include linear low density polyethylene, elastomers, plastomers, high pressure low density polyethylene, high density polyethylene, polypropylenes, and the like. The produced polyethylene and blends including the produced polyethylene may be used to produce blow-molded components or products, among various other end uses. The produced polyethylene and blends including the produced polyethylene may be useful in forming operations such as film, sheet, and fiber extrusion and co-extrusion as well as blow molding, injection molding and rotary molding. Films may include blown or cast films formed by coextrusion or by lamination useful as shrink film, cling film, stretch film, sealing films, oriented films, snack packaging, heavy duty bags, grocery sacks, baked and frozen food packaging, medical packaging, industrial liners, and membranes in food-contact and non-food contact applications. Fibers may include melt spinning, solution spinning and melt blown fiber operations for use in woven or non-woven form to make filters, diaper fabrics, medical garments, and geotextiles. Extruded articles may include medical tubing, wire and cable coatings, pipe, geomembranes, and pond liners. Molded articles may include single and multi-layered constructions in the form of bottles, tanks, large hollow articles, rigid food containers and toys.

### Embodiment Combinations

The following are embodiments and combination of embodiments of the present disclosure. A supported catalyst system comprising a metal-ligand complex disposed on one or more support materials, wherein the metal-ligand complex has a structure according to formula (I):

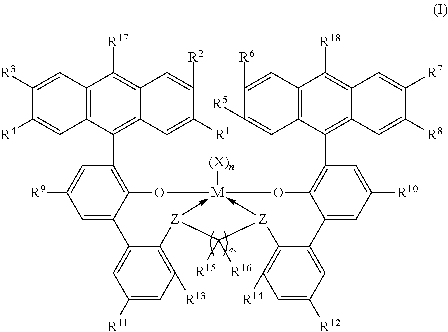

wherein:
M is titanium, zirconium, or hafnium;
n is 1, 2, or 3;
m is 1, 2, 3,4, or 5;
each X is a monodentate ligand independently chosen from (C₁-C₅₀)hydrocarbyl, (C₁-C₅₀)heterohydrocarbyl, (C₆-C₅₀)aryl, (C₄-C₅₀)heteroaryl, halogen, —N(R^{N})₂, N(R^{N})COR^{C}, —OR, —OPh, —OAr and —H;
the metal-ligand complex is overall charge-neutral;
each Z is independently chosen from —O—, —S—, (C₆-C₅₀)aryl, (C₂-C₅₀)heteroaryl, N(C₁-C₅₀)hydrocarbyl, N(C₁-C₅₀)aryl, P(C₁-C₅₀)aryl and P(C₁-C₅₀)hydrocarbyl;
R¹—R⁸ are each independently (C₁-C₂₀)hydrocarbyl, (C₁-C₂₀)heterohydrocarbyl, and —H;
R⁹ and R¹⁰ are independently chosen from (C₁-C₂₀)hydrocarbyl, (C₁-C₂₀)heterohydrocarbyl and —H;
R¹¹ and R¹² are independently chosen from (C₁-C₂₀)hydrocarbyl, (C₁-C₂₀)heterohydrocarbyl, halogen and —H;
R¹³ and R¹⁴ are independently chosen from (C₁-C₂₀)hydrocarbyl, (C₁-C₂₀)heterohydrocarbyl and —H;
R¹⁵ and R¹⁶ are independently chosen from (C₁-C₂₀)hydrocarbyl, (C₁-C₂₀)heterohydrocarbyl and —H;
R¹⁷ and R¹⁸ are both: (C₁-C₂₀)hydrocarbyl, (C₁-C₂₀)heterohydrocarbyl,

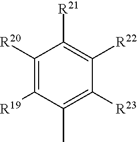

or —H, where R¹⁹⁻²³ are independently chosen from (C₁-C₂₀)hydrocarbyl, (C₁-C₂₀)heterohydrocarbyland —H; and
each R, R^{C} and R^{N} are independently chosen from —H, (C₁-C₅₀)hydrocarbyl, and (C₁-C₅₀)heterohydrocarbyl. In some embodiments, for the supported catalyst system R¹¹ and R¹² are fluorine (F). In some embodiments, for the supported catalyst system Z is —O—. In some embodiments, for the supported catalyst system m is 3. In some embodiments, for the supported catalyst system n is 2 and each X is methyl. In some embodiments, for the supported catalyst system R⁹ and R¹⁰ are each 1,1,-dimethyl-3,3-dimethylbutyl or t-octyl. In some embodiments, for the supported catalyst system R¹, R⁴, R⁵ and R⁸ are each independently (C₁-C₂₀)hydrocarbyl and R², R³, R⁶ and R⁷ are —H or R¹, R⁴, R⁵ and R⁸ are each —H and R², R³, R⁶ and R⁷ are each independently (C₁-C₂₀)hydrocarbyl. In some embodiments, for the supported catalyst system R¹, R⁴, R⁵ and R⁸ are each —H and R², R³, R⁶ and R⁷ are each tert-butyl. In some embodiments, for the supported catalyst system R¹, R⁴, R⁵ and R⁸ are each tert-butyl and R², R³, R⁶ and R⁷ are each —H. In some embodiments, for the supported catalyst system R⁷ and R¹⁸ are both

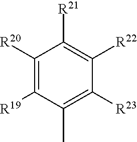

and R²⁰ and R²² are each tert-butyl and R¹⁹, R²¹ and R²³ are each —H. In some embodiments, for the supported catalyst system R¹⁷ and R¹⁸ are both —H. In some embodiments, for the supported catalyst system at least two R groups of R¹⁹⁻²³ are (C₁-C₂₀)hydrocarbyl. In some embodiments, for the supported catalyst system the one or more support materials comprise fumed silica. In some embodiments, for the supported catalyst system the supported catalyst system is a spray-dried supported catalyst system. In some embodiments, the supported catalyst system further includes one or more activators. In some embodiments, for the supported catalyst system the activator comprises methylalumoxane (MAO).

In some embodiments, the present disclosure also provides for a method for producing a supported activated metal-ligand catalyst, the method comprising:
contacting one or more support materials and one or more activators with a metal-ligand complex in an inert hydrocarbon solvent to produce the supported activated metal-ligand catalyst, wherein the metal-ligand complex has a structure according to formula (Ib):

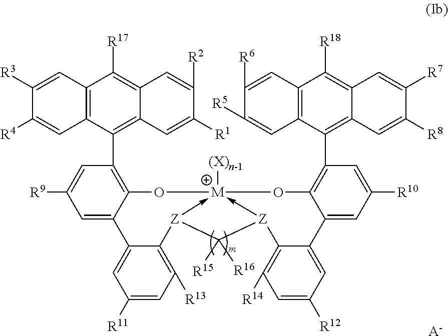

wherein:
A⁻ is an anion;
M is titanium, zirconium, or hafnium;
n is 1, 2, or 3;
m is 1, 2, 3, 4, or 5;
each X is a monodentate ligand independently chosen from (C₁-C₅₀)hydrocarbyl, (C₁-C₅₀)heterohydrocarbyl, (C₆-C₅₀)aryl, (C₄-C₅₀)heteroaryl, halogen, —N(R^{N})₂, N(R^{N})COR^{C}, —OR, —OPh, —OAr and —H;
each Z is independently chosen from —O—, —S—, (C₆-C₅₀)aryl, (C₂-C₅₀)heteroaryl, N(C₁-C₅₀)hydrocarbyl, N(C₁-C₅₀)aryl, P(C₁-C₅₀)aryl and P(C₁-C₅₀)hydrocarbyl;
R¹-R⁸ are each independently (C₁-C₂₀)hydrocarbyl, (C₁-C₂₀)heterohydrocarbyl and —H;
R⁹ and R¹⁰ are independently chosen from (C₁-C₂₀)hydrocarbyl, (C₁-C₂₀)heterohydrocarbyl and —H;
R¹¹ and R¹² are independently chosen from (C₁-C₂₀)hydrocarbyl, (C₁-C₂₀)heterohydrocarbyl, halogen and —H;
R¹³ and R¹⁴ are independently chosen from (C₁-C₂₀)hydrocarbyl, (C₁-C₂₀)heterohydrocarbyl and —H;
R¹⁵ and R¹⁶ are independently chosen from (C₁-C₂₀)hydrocarbyl, (C₁-C₂₀)heterohydrocarbyl and —H;
R¹⁷ and R¹⁸ are both: (C₁-C₂₀)hydrocarbyl, (C₁-C₂₀)heterohydrocarbyl,

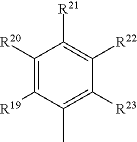

or —H, where R¹⁹⁻²³ are independently chosen from (C₁-C₂₀)hydrocarbyl, (C₁-C₂₀)heterohydrocarbyland —H; and
each R, R^{C} and R^{N} are independently chosen from —H, (C₁-C₅₀)hydrocarbyl, and (C₁-C₅₀)heterohydrocarbyl. In some embodiments, for the method for producing the supported activated metal-ligand catalyst the activator comprises methylalumoxane (MAO). In some embodiments, the method for producing the supported activated metal-ligand catalyst further includes drying the supported activated metal-ligand catalyst, wherein drying includes spray drying the supported activated metal-ligand catalyst to produce particles of a spray-dried supported activated metal-ligand catalyst. In some embodiments, the method for producing the supported activated metal-ligand catalyst further comprises:
disposing the one or more activators on the one or more support materials to produce a supported activator; and
contacting the supported activator with a solution of the metal-ligand complex in the inert hydrocarbon solvent. In some embodiments, for the method for producing the supported activated metal-ligand catalyst disposing the one or more activators on the one or more support materials comprises spray drying to produce a spray-dried supported activator. In some embodiments, for the method for producing the supported activated metal-ligand catalyst at least two R groups of
R¹⁹⁻²³ are (C₁-C₂₀)hydrocarbyl.

In some embodiments, the present disclosure also provides for a process for producing a polyethylene or polyethylene copolymer resin in a gas phase polymerization reactor comprising: contacting ethylene and, optionally, one or more (C₃-C₁₂)α-olefin comonomers with a supported activated metal-ligand catalyst in a gas-phase polymerization reactor, wherein the supported activated metal-ligand catalyst comprises a metal-ligand complex disposed on one or more support materials and one or more activators; wherein the metal-ligand complex has a structure according to formula (Ib):

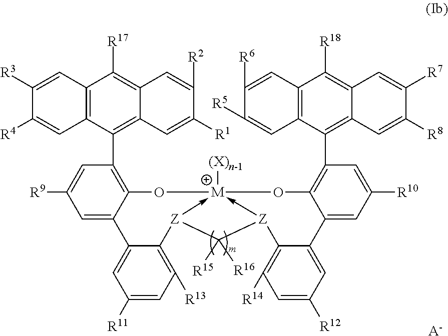

wherein:
A⁻ is an anion;
M is titanium, zirconium, or hafnium;
n is 1, 2, or 3;
m is 1, 2, 3, 4, or 5;
each X is a monodentate ligand independently chosen from (C₁-C₅₀)hydrocarbyl, (C₁-C₅₀)heterohydrocarbyl, (C₆-C₅₀)aryl, (C₄-C₅₀)heteroaryl, halogen, —N(R^{N})₂, N(R^{N})COR^{C}, —OR, —OPh, —OAr and —H;
each Z is independently chosen from —O—, —S—, (C₆-C₅₀)aryl, (C₂-C₅₀)heteroaryl, N(C₁-C₅₀)hydrocarbyl, N(C₁-C₅₀)aryl, P(C₁-C₅₀)aryl and P(C₁-C₅₀)hydrocarbyl;
R¹—R⁸ are each independently (C₁-C₂₀)hydrocarbyl, (C₁-C₂₀)heterohydrocarbyl and —H;
R⁹ and R¹⁰ are independently chosen from (C₁-C₂₀)hydrocarbyl, (C₁-C₂₀)heterohydrocarbyl and —H;
R¹¹ and R¹² are independently chosen from (C₁-C₂₀)hydrocarbyl, (C₁-C₂₀)heterohydrocarbyl, halogen and —H;
R¹³ and R¹⁴ are independently chosen from (C₁-C₂₀)hydrocarbyl, (C₁-C₂₀)heterohydrocarbyl and —H;
R¹⁵ and R¹⁶ are independently chosen from (C₁-C₂₀)hydrocarbyl, (C₁-C₂₀)heterohydrocarbyl and —H;
R¹⁷ and R¹⁸ are both: (C₁-C₂₀)hydrocarbyl, (C₁-C₂₀)heterohydrocarbyl,

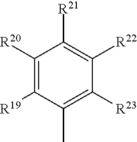

or —H, where R¹⁹⁻²³ are independently chosen from (C₁-C₂₀)hydrocarbyl, (C₁-C₂₀)heterohydrocarbyland —H; and
each R, R^{C} and R^{N} are independently chosen from —H, (C₁-C₅₀)hydrocarbyl, and (C₁-C₅₀)heterohydrocarbyl. In some embodiments, for the process for producing the polyethylene or polyethylene copolymer resin in the gas phase polymerization reactor the activator comprises methylalumoxane (MAO). In some embodiments, for the process for producing the polyethylene or polyethylene copolymer resin in the gas phase polymerization reactor the catalyst system is fed to the gas-phase polymerization reactor in neat form, as a solution, or as a slurry. In some embodiments, for the process for producing the polyethylene or polyethylene copolymer resin in the gas phase polymerization reactor the supported catalyst system is a spray dried supported catalyst system. In some embodiments, for the process for producing the polyethylene or polyethylene copolymer resin in the gas phase polymerization reactor at least two R groups of R¹⁹⁻²³ are (C₁-C₂₀)hydrocarbyl.

### Test Methods

### Polymerization Activity

Unless indicated otherwise, all polymerization activities (also referred to as Catalyst Productivity) are determined as a ratio of polymer produced to the amount of catalyst added to the reactor and are reported in grams of polymer per grams of catalyst per hour (gPE/gCat/hr).

### Comonomer Content

Unless indicated otherwise, all comonomer contents (i.e., the amount of comonomer incorporated into a polymer) presently disclosed were determined by rapid FT-IR spectroscopy on dissolved polymer in a Gel Permeation Chromatography (GPC) measurement and are reported in weight percent (wt. %). The comonomer content of a polymer can be determined with respect to polymer molecular weight by use of an infrared detector, such as an IR5 detector, in a GPC measurement, as described in Lee et al., Toward absolute chemical composition distribution measurement of polyolefins by high-temperature liquid chromatography hyphenated with infrared absorbance and light scattering detectors, 86 ANAL. CHEM. 8649 (2014).

### High Load Melt Index (12)

Unless indicated otherwise, all high load melt indices (121) disclosed herein were measured according to ASTM D1238-10, Method B, at 190° C. and a 21.6 kg load, and are reported in decigrams per minute (dg/min).

### Melt Index (I₅)

Unless indicated otherwise, all melt indices (I₅) disclosed herein were measured according to ASTM D1238-04 at 190° C. and a 5.0 kg load, and are reported in decigrams per minute (dg/min).

### Melt Index (I₂)

Unless indicated otherwise, all melt indices (I₂) disclosed herein were measured according to ASTM D1238-04 at 190° C. and a 2.16 kg load, and are reported in decigrams per minute (dg/min).

### Melt Temperature (Tₘ)

Unless indicated otherwise, all melt temperatures (Tₘ) disclosed herein were measured according to ASTM D3418-08 and are reported in degrees Celsius (° C.). Unless indicated otherwise, a scan rate of 10 degrees Celsius per minute (° C./min) on a 10 milligram (mg) sample was used, and the second heating cycle was used to determine the melt temperature (Tₘ).

### Molecular Weight

Unless indicated otherwise, all molecular weights disclosed herein, including weight average molecular weight (M_{w}), number average molecular weight (Mₙ), and z-average molecular weight (M_{z}), were measured using conventional gel permeation chromatography (GPC) and are reported in grams per mole (g/mol).

The GPC chromatographic system consisted of a High Temperature Gel Permeation Chromatography (Polymer Laboratories), equipped with a differential refractive index detector (DRI). Three Polymer Laboratories PLgel 10 μm Mixed-B columns were used. The nominal flow rate was 1.0 mL/min, and the nominal injection volume was 300 μL. The various transfer lines, columns, and differential refractometer (the DRI detector) were contained in an oven maintained at 160° C. The solvent for the experiment was prepared by dissolving 6 grams of butylated hydroxytoluene as an antioxidant in 4 liters of Aldrich reagent-grade 1,2,4-trichlorobenzene (TCB). The TCB mixture was then filtered through a 0.1 μm Teflon filter. The TCB was then degassed with an online degasser before entering the GPC instrument.

The polymer solutions were prepared by placing dry polymer in glass vials, adding the desired amount of TCB, then heating the mixture at 160° C. with continuous shaking for about 2 hours. All quantities were measured gravimetrically. The injection concentration was from 0.5 to 2.0 mg/ml, with lower concentrations being used for higher molecular weight samples. Prior to running each sample, the DRI detector was purged. The flow rate in the apparatus was then increased to 1.0 ml/minute, and the DRI was allowed to stabilize for 8 hours before injecting the first sample. The molecular weight was determined by combining universal calibration relationship with the column calibration which is performed with a series of monodispersed polystyrene (PS) standards. The M_{w} was calculated at each elution volume with following equation:

$$log {M}_{X} = \frac{log ( {K}_{X} / {K}_{PS} )}{{a}_{X} + 1} + \frac{{a}_{PS} + 1}{{a}_{X} + 1} log {M}_{PS}$$

where the variables with subscript “X” stand for the test sample while those with subscript “PS” stand for PS. In this method, α_{Ps}=0.67 and K_{Ps}=0.000175 while aₓ and Kₓ were obtained from published literature. Specifically, a/K=0.695/0.000579 for PE and 0.705/0.0002288 for PP.

The concentration, c, at each point in the chromatogram was calculated from the baseline-subtracted DRI signal, IDRI, using the following equation:

$$c = \frac{KDRI \times IDRI}{dn / dc}$$

where KDRI is a constant determined by calibrating the DRI, and (dn/dc) is the refractive index increment for the system. Specifically, dn/dc=0.109 for polyethylene.

The mass recovery was calculated from the ratio of the integrated area of the concentration chromatography over elution volume and the injection mass which is equal to the pre-determined concentration multiplied by injection loop volume.

### EXAMPLES

All solvents and reagents were obtained from commercial sources and used as received unless otherwise noted. Anhydrous toluene, hexanes, tetrahydrofuran, and diethyl ether were purified via passage through activated alumina and, in some cases, Q-5 reactant. Solvents used for experiments performed in a nitrogen-filled glovebox were further dried by storage over activated 3 Å molecular sieves. Glassware for moisture-sensitive reactions was dried in a 150° C. oven overnight prior to use. NMR spectra were recorded on Varian 400-MR and VNMRS-500 spectrometers. LC-MS analyses were performed using a Waters e2695 Separations Module coupled with a Waters 2424 ELS detector, a Waters 2998 PDA detector, and a Waters 3100 ESI mass detector. LC-MS separations were performed on an XBridge C18 3.5 μm 2.1×50 mm column using a 5:95 to 100:0 acetonitrile to water gradient with 0.1% formic acid as the ionizing agent. HRMS analyses were performed using an Agilent 1290 Infinity LC with a Zorbax Eclipse Plus C18 1.8 μm 2.1×50 mm column coupled with an Agilent 6230 TOF Mass Spectrometer with electrospray ionization. ¹H NMR data are reported as follows: chemical shift (multiplicity (br=broad, s=singlet, d=doublet, t=triplet, q=quartet, p=pentet, sex=sextet, sept=septet and m=multiplet), integration, and assignment). Chemical shifts for ¹H NMR data are reported in ppm downfield from internal tetramethylsilane (TMS, 6 scale) using residual protons in the deuterated solvent as references. ¹³C NMR data were determined with ¹H decoupling, and the chemical shifts are reported downfield from tetramethylsilane (TMS, 6 scale) in parts per million (ppm) versus the using residual carbons in the deuterated solvent as references.

### Synthesis of Ligand 1

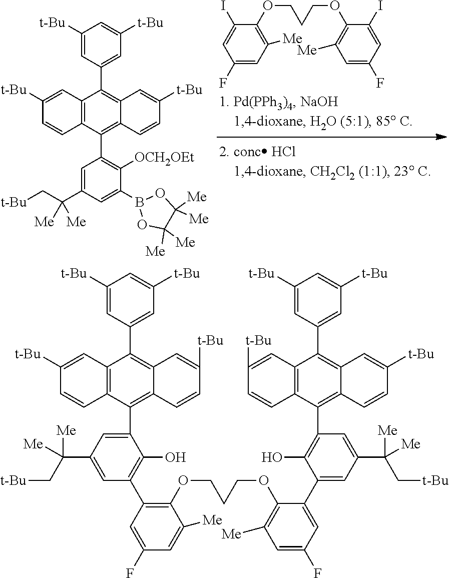

A solid mixture of the boropinacolate ester (0.500 g, 0.5766 mmol, 2.80 eq), bis-iodide (0.112 g, 0.2059 mmol, 1.00 eq), Pd(PPh₃)₄ (24.0 mg, 0.0206 mmol, 0.10 eq), and solid NaOH (74.0 mg, 1.853 mmol, 9.00 eq) in a round-bottom flask equipped with a reflux condenser sealed with a rubber septa was evacuated, back-filled with nitrogen, the evacuation/nitrogen re-fill process was repeated three times, then freshly sparged deoxygenated 1,4-dioxane (10 mL) and H₂O (2 mL) were added via syringe, and the resultant canary yellow mixture was placed in a mantle heated to 85° C. After stirring (300 rpm) for 36 hrs, the now black mixture was removed from the mantle, allowed to cool to 23° C., diluted with CH₂Cl₂ (20 mL), the biphasic mixture was suction filtered through a pad of silica gel, rinsed with CH₂Cl₂ (4×20 mL), the filtrate was concentrated onto celite, and purified via silica gel chromatography; 10%-40% CH₂Cl₂ in hexanes to afford the protected coupled product as a dark red/purple amorphous foam (0.352 g, 0.1988 mmol, 97%). NMR indicated product.

To a solution the coupled product (0.352 g) from above in 1,4-dioxane and CH₂Cl₂ (10 mL, 1:1) under nitrogen at 23° C. was added aqueous conc. HCl (5 mL, 37% w/w). After stirring (300 rpm) for 16 hrs, the dark golden brown mixture was diluted with water (25 mL) and CH₂Cl₂ (25 mL), the biphasic mixture was poured into a separatory funnel, partitioned, organics were washed with water (1×25 mL), residual organics were extracted with CH₂Cl₂ (2×25 mL), combined, dried over solid Na₂SO₄, decanted, concentrated onto celite, and purified via silica gel chromatography; 10%-40% CH₂Cl₂ in hexanes to afford Ligand 1 as a pale yellow foam (0.280 g, 0.1692 mmol, 82%, 80% two steps). NMR indicated product.

¹H NMR (500 MHz, Chloroform-d) δ 7.74 (d, J=2.0 Hz, 4H), 7.64 (d, J=9.2 Hz, 4H), 7.56 (t, J=1.8 Hz, 2H), 7.49 (d, J=2.5 Hz, 2H), 7.38 (ddt, J=20.8, 5.6, 2.8 Hz, 10H), 7.07 (dd, J=9.0, 3.2 Hz, 2H), 6.87 (dd, J=8.8, 3.1 Hz, 2H), 6.32 (s, 2H), 3.80 (t, J=6.5 Hz, 4H), 2.07 (s, 6H), 1.99-1.91 (m, 2H), 1.77 (s, 4H), 1.44 (s, 18H), 1.42 (s, 18H), 1.41 (s, 12H), 1.23 (s, 36H), 0.84 (s, 18H).

¹⁹F NMR (470 MHz, Chloroform-d) δ-118.59.

¹³C NMR (126 MHz, Chloroform-d) δ 158.96 (d, J=242.8 Hz), 150.27 (d, J=2.2 Hz), 150.10-149.98 (m), 149.18, 146.67, 142.22, 138.40, 137.86, 133.87 (d, J=8.6 Hz), 133.25 (d, J=8.6 Hz), 131.57, 130.93, 130.10, 128.72, 128.57, 126.85, 126.05, 126.02, 124.93 (d, J=1.5 Hz), 124.26, 121.97, 120.39, 116.76 (d, J=22.5 Hz), 116.43 (d, J=23.0 Hz), 71.03, 57.16, 38.19, 35.04, 35.02, 34.87, 34.68, 32.50, 31.98, 31.82, 31.67, 31.64, 30.86, 30.74, 16.56.

### Synthesis of Ligand 2

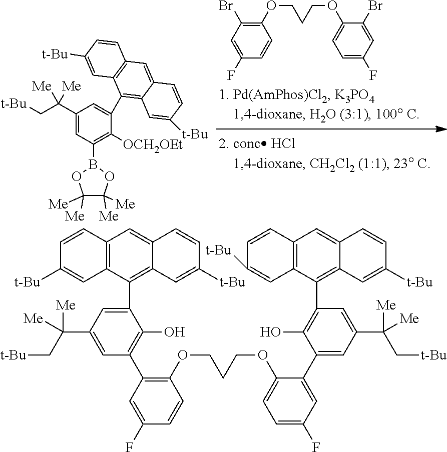

A solid mixture of the boropinacolate ester (0.819 g, 1.232 mmol, 3.00 eq), bis-bromide (0.173 g, 0.4107 mmol, 1.00 eq), Pd(AmPhos)Cl₂ (58.0 mg, 0.0821 mmol, 0.20 eq), and solid K₃PO₄ (0.785 g, 3.696 mmol, 9.00 eq) in a round-bottom flask equipped with a reflux condenser sealed with a rubber septa was evacuated, back-filled with nitrogen, the evacuation/nitrogen re-fill process was repeated three times, then freshly sparged deoxygenated 1,4-dioxane (15 mL) and H₂O (5 mL) were added via syringe, and the resultant canary yellow mixture was placed in a mantle heated to 100° C. After stirring (300 rpm) for 36 hrs, the now black mixture was removed from the mantle, allowed to cool to 23° C., diluted with CH₂Cl₂ (20 mL), the biphasic mixture was suction filtered through a pad of silica gel, rinsed with CH₂Cl₂ (4×20 mL), the filtrate was concentrated onto celite, and purified via silica gel chromatography; 10%-50% CH₂Cl₂ in hexanes to afford the protected coupled product as a golden yellow foam (0.486 g, 0.3558 mmol, 87%). NMR indicated product.

To a solution the coupled product (0.486 g, 0.3558 mmol) from above in 1,4-dioxane and CH₂Cl₂ (12 mL, 1:1) under nitrogen at 23° C. was added aqueous conc. HCl (5 mL, 37% w/w). After stirring (300 rpm) for 16 hrs, the dark golden brown mixture was diluted with water (25 mL) and CH₂Cl₂ (25 mL), the biphasic mixture was poured into a separatory funnel, partitioned, residual organics were extracted with CH₂Cl₂ (2×25 mL), combined, dried over solid Na₂SO₄, decanted, concentrated onto celite, and purified via silica gel chromatography; 10%-50% CH₂Cl₂ in hexanes to afford Ligand 2 as a white solid (0.261 g, 0.2088 mmol, 59%, 51% two steps). NMR indicated product.

¹H NMR (500 MHz, CDCl₃) δ 8.52 (s, 2H), 8.05 (d, J=8.8 Hz, 4H), 7.57 (d, J=10.9 Hz, 8H), 7.29 (dt, J=5.9, 2.4 Hz, 4H), 6.95 (dd, J=8.9, 3.2 Hz, 2H), 6.32 (td, J=8.4, 3.2 Hz, 2H), 5.58 (dd, J=9.1, 4.4 Hz, 2H), 4.83 (s, 2H), 3.63 (t, J=5.4 Hz, 4H), 1.82 (p, J=5.6 Hz, 2H), 1.75 (s, 4H), 1.39 (s, 12H), 1.26 (s, 36H), 0.81 (s, 18H).

¹³C NMR (126 MHz, CDCl₃) δ 156.79 (d, J=238.8 Hz), 151.41 (d, J=1.9 Hz), 148.94, 147.83, 141.49, 131.92, 130.83, 129.97, 129.94, 128.90 (d, J=7.8 Hz), 128.54, 128.15, 125.79, 124.72, 124.59, 124.46, 118.00 (d, J=23.0 Hz), 114.49 (d, J=22.8 Hz), 112.14 (d, J=8.6 Hz), 64.45, 56.75, 38.08, 35.01, 32.49, 32.11, 32.04, 30.82, 29.13.

¹⁹F NMR (471 MHz, CDCl₃) δ−123.81-−123.95 (m).

### Synthesis of Intermediates for Ligands 1 and 2

### Boropinacolate Ester Intermediate of Ligand 1

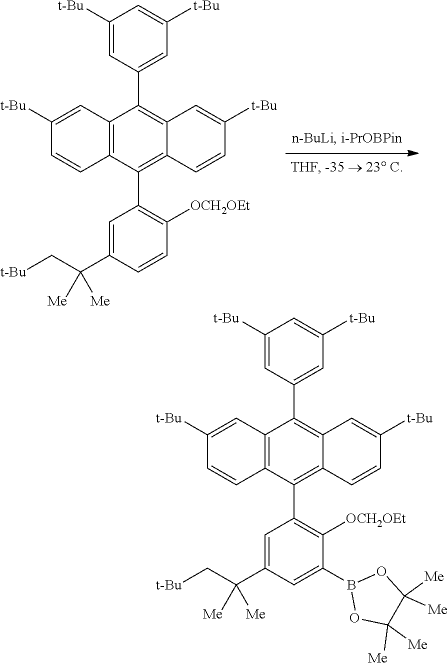

Prior to the experiment, the starting protected phenol was azeotropically dried using anhydrous toluene (4×10 mL). In a continuous purge, nitrogen filled glovebox, a clear golden yellow solution of the protected phenol (2.306 g, 3.111 mmol, 1.00 eq) in anhydrous deoxygenated THF (50 mL) was placed in a freezer cooled to −35° C. for 2 hrs, upon which a solution of n-BuLi (2.50 mL, 6.223 mmol, 2.00 eq, 2.5 M in hexanes) was added via syringe in a quick dropwise manner. The now darker golden brown solution was allowed to sit in the freezer for 1 hr, removed, stirred (300 rpm) at 23° C. for 2.5 hrs, the now dark golden yellow solution was placed back in the freezer cooled to −35° C. for 1 hr, and neat isopropoxyboropinacolate ester (1.90 mL, 9.333 mmol, 3.00 eq) was then added neat via syringe in a quick dropwise manner. The now white mixture was removed from the freezer, and stirred (300 rpm) at 23° C. for 3 hrs. The white mixture was removed from the glovebox, diluted with water (50 mL), THF was removed via rotary evaporation, the biphasic mixture was diluted with CH₂Cl₂ (50 mL), poured into a separatory funnel, partitioned, organics were washed with water (1×25 mL), residual organics were extracted from the aqueous (2×25 mL), combined, dried over solid Na₂SO₄, decanted, and concentrated to afford the boropinacolate ester as an off-white foam (2.650 g, 3.056 mmol, 98%). NMR indicated product. The crude material was used in the subsequent reaction without further purification.

¹H NMR (500 MHz, cdcl₃) δ 7.93 (d, J=2.6 Hz, 1H), 7.67 (dd, J=2.0, 0.6 Hz, 2H), 7.62 (dd, J=9.2, 0.6 Hz, 2H), 7.52 (t, J=1.9 Hz, 1H), 7.47 (d, J=2.7 Hz, 1H), 7.39 (dd, J=9.2, 2.0 Hz, 2H), 7.36-7.34 (m, 1H), 7.23 (t, J=1.6 Hz, 1H), 4.76 (s, 2H), 2.17 (q, J=7.0 Hz, 2H), 1.76 (s, 2H), 1.41 (s, 9H), 1.41 (s, 6H), 1.40 (s, 9H), 1.38 (s, 12H), 1.26 (s, 18H), 0.83 (s, 9H), 0.19 (t, J=7.0 Hz, 3H).

¹³C NMR (126 MHz, cdcl₃) δ 159.23, 150.24, 150.08, 146.45, 145.01, 138.09, 137.71, 134.42, 134.31, 133.37, 131.83, 129.73, 128.64, 127.02, 126.09, 125.86, 123.95, 121.34, 120.29, 99.18, 83.58, 64.00, 56.85, 38.36, 35.00, 34.94, 34.88, 32.48, 32.03, 31.75, 31.64, 31.63, 30.89, 24.86, 13.81

### Synthesis of Intermediate to Ligand 1

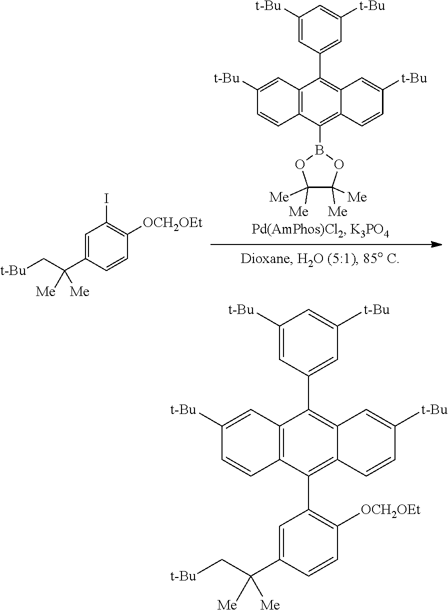

A solid mixture of the boropinacolate ester (2.759 g, 4.562 mmol, 1.30 eq), aryl iodide (1.370 g, 3.510 mmol, 1.00 eq), Pd(AmPhos)Cl₂ (0.249 g, 0.3510 mmol, 0.10 eq), and solid K₃PO₃ (3.725 g, 17.550 mmol, 5.00 eq) in a round-bottom flask equipped with a reflux condenser sealed with a rubber septa was evacuated, back-filled with nitrogen, the evacuation/nitrogen re-fill process was repeated three times, then freshly sparged deoxygenated 1,4-dioxane (30 mL) and H₂O (6 mL) were added via syringe, and the resultant canary yellow mixture was placed in a mantle heated to 85° C. After stirring (300 rpm) for 42 hrs, the now dark purple/black mixture was removed from the mantle, allowed to cool to 23° C., diluted with CH₂Cl₂ (25 mL), the biphasic mixture was suction filtered through a pad of silica gel, rinsed with CH₂Cl₂ (4×30 mL), the filtrate was concentrated onto celite, and purified via silica gel chromatography; hexanes—10% CH₂Cl₂ in hexanes to afford the protected aryl anthracene as a golden yellow foam (2.306 g, 3.111 mmol, 87%). NMR indicated product.

¹H NMR (400 MHz, cdcl₃) δ 7.75 (dd, J=2.0, 0.7 Hz, 2H), 7.63 (dd, J=9.2, 0.7 Hz, 2H), 7.55 (t, J=1.9 Hz, 1H), 7.51 (dd, J=8.7, 2.5 Hz, 1H), 7.41 (dd, J=9.3, 1.9 Hz, 3H), 7.37-7.31 (m, 3H), 4.98 (s, 2H), 3.29 (q, J=7.1 Hz, 2H), 1.76 (s, 2H), 1.45 (s, 9H), 1.42 (s, 9H), 1.41 (s, 6H), 1.30 (s, 18H), 1.00 (t, J=7.1 Hz, 4H), 0.84 (s, 9H).

¹³C NMR (101 MHz, cdcl₃) δ 153.48, 150.20, 150.13, 146.42, 143.50, 138.03, 137.74, 133.09, 131.01, 129.92, 128.48, 128.35, 126.70, 126.21, 123.75, 121.61, 120.24, 114.97, 93.37, 63.92, 57.06, 38.20, 35.05, 35.03, 34.92, 32.48, 31.96, 31.69, 30.91, 14.92.

### Synthesis of Boropinacolate Ester Intermediate to Ligand 2

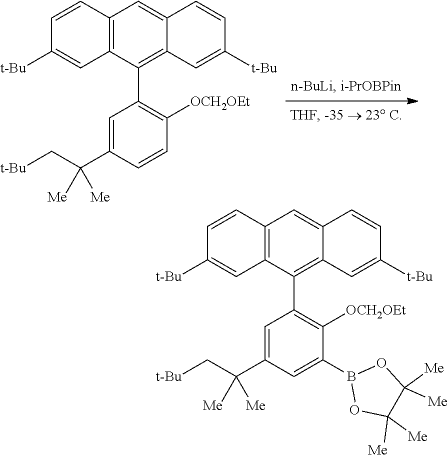

Prior to the experiment, the starting protected phenol was azeotropically dried using anhydrous toluene (4×10 mL). In a continuous purge, nitrogen filled glovebox, a clear golden yellow solution of the protected phenol (2.740 g, 4.956 mmol, 1.00 eq) in anhydrous deoxygenated THF (100 mL) was placed in a freezer cooled to −35° C. for 2 hrs, upon which a solution of n-BuLi (4.0 mL, 9.912 mmol, 2.00 eq, 2.5 M in hexanes) was added via syringe in a quick dropwise manner. The now darker golden brown solution was allowed to sit in the freezer for 1 hr, removed, stirred (300 rpm) at 23° C. for 2.5 hrs, the now dark golden yellow solution was placed back in the freezer cooled to −35° C. for 1 hr, and neat isopropoxyboropinacolate (3.0 mL, 14.868 mmol, 3.00 eq) was then added neat via syringe in a quick dropwise manner. The now white mixture was removed from the freezer, and stirred (300 rpm) at 23° C. for 3 hrs. The white mixture was removed from the glovebox, diluted with water (50 mL), THF was removed via rotary evaporation, the biphasic mixture was diluted with CH₂Cl₂ (50 mL), poured into a separatory funnel, partitioned, organics were washed with water (1×25 mL), residual organics were extracted from the aqueous (2×25 mL), combined, dried over solid Na₂SO₄, decanted, and concentrated to afford the boropinacolate ester as a canary yellow foam (3.274 g, 4.823 mmol, 97%). NMR indicated product. The crude material was used in the subsequent reaction without further purification.

¹H NMR (500 MHz, cdcl₃) δ 8.35 (s, 1H), 7.93 (dt, J=8.7, 0.7 Hz, 2H), 7.89 (d, J=2.6 Hz, 1H), 7.53 (dt, J=1.8, 0.8 Hz, 2H), 7.50 (dd, J=8.8, 1.9 Hz, 2H), 7.42 (d, J=2.7 Hz, 1H), 4.65 (s, 2H), 2.23 (q, J=7.1 Hz, 2H), 1.75 (s, 2H), 1.40 (s, 6H), 1.38 (s, 12H), 1.27 (s, 18H), 0.77 (s, 9H), 0.25 (t, J=7.1 Hz, 3H).

### Synthesis of Intermediate to Ligand 2

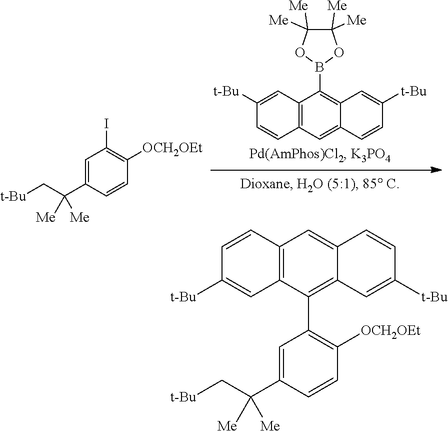

A solid mixture of the boropinacolate ester (3.961 g, 9.512 mmol, 1.30 eq), aryl iodide (2.856 g, 7.317 mmol, 1.00 eq), Pd(AmPhos)Cl₂ (0.518 g, 0.7317 mmol, 0.10 eq), and solid K₃PO₃ (7.766 g, 36.585 mmol, 5.00 eq) in a round-bottom flask equipped with a reflux condenser sealed with a rubber septa was evacuated, back-filled with nitrogen, the evacuation/nitrogen re-fill process was repeated three times, then freshly sparged deoxygenated 1,4-dioxane (60 mL) and H₂O (12 mL) were added via syringe, and the resultant canary yellow mixture was placed in a mantle heated to 85° C. After stirring (300 rpm) for 42 hrs, the now dark purple/black mixture was removed from the mantle, allowed to cool to 23° C., diluted with CH₂Cl₂ (25 mL), the biphasic mixture was suction filtered through a pad of silica gel, rinsed with CH₂Cl₂ (4×30 mL), the filtrate was concentrated onto celite, and purified via silica gel chromatography; hexanes—10% CH₂Cl₂ in hexanes to afford the protected aryl anthracene as a golden yellow foam (2.740 g, 4.956 mmol, 68%). NMR indicated product.

¹H NMR (500 MHz, cdcl₃) δ 8.37 (s, 1H), 7.98-7.94 (m, 2H), 7.54-7.50 (m, 4H), 7.46 (dd, J=8.7, 2.5 Hz, 1H), 7.32-7.27 (m, 2H), 4.93 (s, 2H), 3.26 (q, J=7.1 Hz, 2H), 1.73 (s, 2H), 1.38 (s, 6H), 1.26 (s, 18H), 0.97 (t, J=7.1 Hz, 3H), 0.76 (s, 9H).

¹³C NMR (126 MHz, cdcl₃) δ 153.47, 147.00, 143.05, 133.90, 130.81, 130.46, 129.71, 127.92, 127.60, 126.43, 125.01, 124.11, 121.09, 114.32, 93.23, 63.72, 56.61, 38.11, 34.95, 32.46, 32.09, 31.98, 30.88, 14.96.

### Synthesis of Protected Iodo-intermediate to Ligands 1 and 2

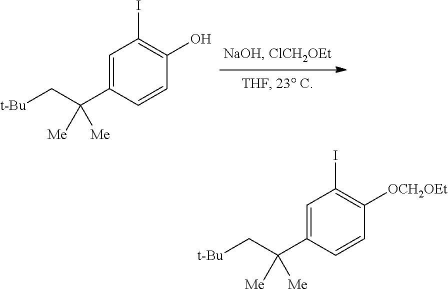

A clear, colorless solution of the iodo-phenol (4.920 g, 14.809 mmol, 1.00 eq) in THF (100 mL) was sparged under positive flow of nitrogen for 15 mins upon which an aqueous solution of NaOH (1.8 mL, 22.214 mmol, 1.50 eq, 50% w/w) was added via syringe in a quick dropwise manner. After stirring (500 rpm) for 30 mins at 23° C., neat chloromethyl ethyl ether (2.7 mL, 29.618 mmol, 2.00 eq) was added via syringe in a quick dropwise manner to the clear colorless solution. After stirring for 2 hrs at 23° C., the now white heterogeneous mixture was diluted with aqueous NaOH (50 mL, 1 N), THF was removed via rotary evaporation, the resultant white biphasic mixture was diluted with CH₂Cl₂ (100 mL), poured into a separatory funnel, partitioned, organics were washed with aqueous NaOH (2×50 mL, 1 N), residual organics were extracted from the aqueous (2×25 mL), combined, dried over solid Na₂SO₄, decanted, and concentrated. The resultant pale yellow oil was diluted in CH₂Cl₂ (20 mL), suction filtered through a silica gel pad, rinsed with CH₂Cl₂ (4×25 mL), and the filtrate was concentrated to afford the phenolic methyl ethyl ether as a clear colorless oil (5.720 g, 14.661 mmol, 99%). NMR indicated pure product.

¹H NMR (500 MHz, cdcl₃) δ 7.73 (d, J=2.4 Hz, 1H), 7.29-7.23 (m, 1H), 6.99 (d, J=8.7 Hz, 1H), 5.25 (s, 2H), 3.77 (q, J=7.1 Hz, 2H), 1.68 (s, 2H), 1.32 (s, 6H), 1.22 (t, J=7.1 Hz, 3H), 0.73 (s, 9H).

¹³C NMR (126 MHz, cdcl₃) δ 153.81, 145.77, 137.11, 127.19, 114.24, 93.80, 86.82, 64.58, 56.86, 37.97, 32.36, 31.82, 31.50, 15.08.

### Synthesis of Bromo-di-t-Butylanthracene

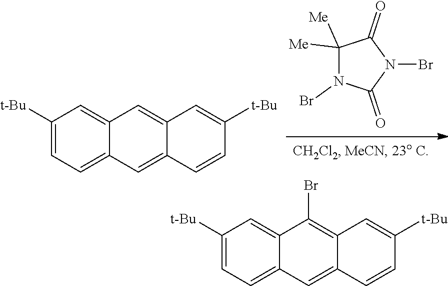

To a pale yellow slight suspension of the di-t-butylanthracene (5.000 g, 17.215 mmol, 1.00 eq) in CH₂Cl₂/MeCN (150 mL, 1:1) at 23° C. was added solid dibromo-dimethylhydantoin (2.461 g, 8.607 mmol, 0.50 eq) all at once. The now dark golden yellow suspension was stirred (500 rpm) for 90 mins upon which the mixture was concentrated onto Celite*, and purified via silica gel chromatography using hexanes as the eluent to afford the bromo-di-t-butylanthracene as an off-white powder (6.167 g, 16.698 mmol, 97%). NMR indicated pure product.

¹H NMR (400 MHz, Chloroform-d) δ 8.40 (dt, J=1.6, 0.7 Hz, 2H), 8.31 (s, 1H), 7.90 (dt, J=8.9, 0.6 Hz, 2H), 7.56 (dd, J=8.8, 1.8 Hz, 2H), 1.47 (s, 18H).

¹³C NMR (101 MHz, Chloroform-d) δ 149.61, 130.53, 130.51, 128.26, 125.81, 124.83, 122.25, 121.90, 35.41, 30.93.

### Synthesis of 3,5-Di-t-Butylphenyl-bis-t-Butylanthracene

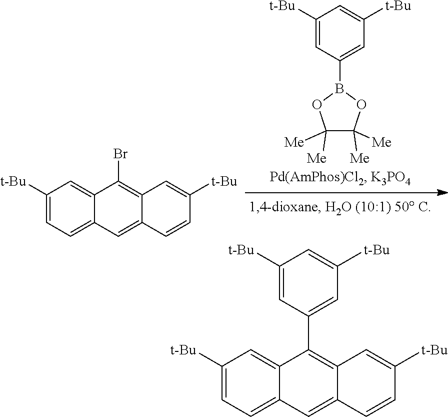

A mixture of the bromoanthracene (0.623 g, 1.687 mmol, 1.00 eq), Pd(AmPhos)Cl₂ (0.119 g, 0.1687 mmol, 0.10 eq), K₃PO₄ (1.611 g, 7.590 mmol, 4.50 eq), and the boropinacolate ester (0.800 g, 2.530 mmol, 1.50 eq) was evacuated, then back-filled with nitrogen, this was repeated 4× more, then freshly sparged deoxygenated 1,4-dioxane (15 mL) and water (1.5 mL) was added, the canary yellow mixture was placed in a mantle heated to 50° C., after stirring for 6 hrs TLC indicated complete consumption of the starting bromoanthracene, the now purple-black mixture was diluted with CH₂Cl₂ (20 mL), suction filtered through a pad of silica gel, rinsed with CH₂Cl₂ (4×20 mL), the filtrate was concentrated onto celite, and purified via silica gel chromatography; hexanes to afford the 3,5-di-t-butylphenyl-bis-t-butylanthracene as a white foam (0.791 g, 1.653 mmol, 98%). NMR indicated pure product.

¹H NMR (400 MHz, Chloroform-d) δ 8.40 (s, 1H), 8.00 (dd, J=8.9, 0.6 Hz, 2H), 7.77 (dt, J=1.8, 0.8 Hz, 2H), 7.60-7.56 (m, 3H), 7.38 (d, J=1.8 Hz, 2H), 1.46 (s, 18H), 1.36 (s, 18H).

¹³C NMR (101 MHz, Chloroform-d) δ 150.24, 147.03, 137.89, 137.64, 130.23, 129.88, 128.00, 126.02, 125.01, 124.13, 122.16, 121.44, 120.43, 35.09, 35.04, 31.69, 30.98.

### Synthesis of Bromoanthracene Intermediate to Ligand 1

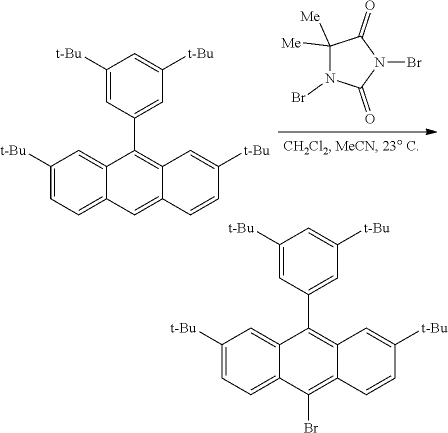

To a pale yellow solution of the di-t-butylanthracene (2.526 g, 5.276 mmol, 1.00 eq) in CH₂Cl₂/MeCN (100 mL, 1:1) at 23° C. was added solid dibromo-dimethylhydantoin (0.800 g, 2.796 mmol, 0.53 eq) all at once. The golden yellow suspension was stirred (500 rpm) for 4 hrs upon which TLC indicated full conversion of the starting anthracene. The solution was concentrated onto celite, and purified via silica gel chromatography; hexanes to afford the bromoanthracene as a white foam (2.740 g, 4.913 mmol, 93%). NMR indicated pure product.

¹H NMR (400 MHz, Chloroform-d) δ 8.58 (d, J=9.3 Hz, 2H), 7.75 (d, J=1.8 Hz, 2H), 7.72 (dd, J=9.2, 2.0 Hz, 2H), 7.62 (t, J=1.8 Hz, 1H), 7.36 (d, J=1.8 Hz, 2H), 1.47 (s, 18H), 1.36 (s, 18H).

¹³C NMR (101 MHz, Chloroform-d) δ 150.47, 147.34, 138.56, 137.38, 131.17, 128.66, 127.50, 125.96, 125.88, 122.17, 122.02, 120.74, 35.06, 34.95, 31.68, 30.88.

### Synthesis of Anthracenyl Boropinacolate Ester Intermediate to Ligand 1

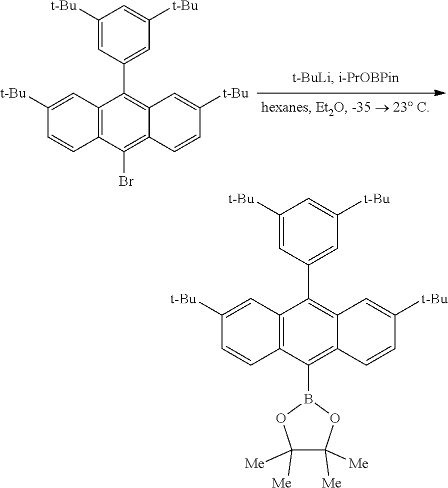 [SMILES: CC(C)(C)c1cc(-c2c3cc(C(C)(C)C)ccc3c(Br)c3ccc(C(C)(C)C)cc23)cc(C(C)(C)C)c1 ; CC(C)(C)c1cc(-c2c3cc(C(C)(C)C)ccc3c(B3OC(C)(C)C(C)(C)O3)c3ccc(C(C)(C)C)cc23)cc(C(C)(C)C)c1]

To a precooled solution of t-BuLi (5.8 mL, 9.827 mmol, 2.00 eq, 1.7 M in pentane) in anhydrous deoxygenated hexanes (50 mL) in a nitrogen filled glovebox at −35° C. (precooled for 16 hrs) was added the solid anthracenylbromide (2.740 g, 4.913 mmol, 1.00 eq). Then, precooled Et₂O (20 mL) was added in a quick dropwise manner while stirring vigorously (1000 rpm). The now dark brown mixture was allowed to sit in the freezer (−35° C.) for 4 hrs upon which neat i-PrOBPin (3.0 mL, 14.739 mmol, 3.00 eq) was added via syringe to the now red-brown mixture. The now pale yellow heterogeneous mixture was allowed to stir at 23° C. for 3 hrs, the mixture was removed from the glovebox, water (20 mL) and Et₂₀ (30 mL) were added sequentially, the biphasic mixture was stirred for 2 mins, poured into a separatory funnel, partitioned, organics were washed with water (2×25 mL), residual organics were extracted with Et₂₀ (2×25 mL), combined, dried over solid Na₂SO₄, decanted, concentrated, the resultant pale yellow mixture was suspended in CH₂Cl₂ (20 mL), suction filtered through silica gel, rinsed with CH₂Cl₂ (4×25 mL), and the resulting filtrate solution was concentrated to afford the anthracenyl boropinacolate ester as a pale yellow foam (2.882 g, 4.766 mmol, 97%). NMR indicated product.

¹H NMR (500 MHz, Chloroform-d) δ 8.49 (dd, J=9.1, 0.6 Hz, 2H), 7.70 (dd, J=2.1, 0.7 Hz, 2H), 7.61 (dd, J=9.2, 2.1 Hz, 2H), 7.56 (t, J=1.9 Hz, 1H), 7.31 (d, J=1.8 Hz, 2H), 1.62 (s, 12H), 1.43 (s, 18H), 1.32 (s, 18H).

¹³C NMR (126 MHz, Chloroform-d) δ 150.88, 150.20, 146.33, 140.60, 138.05, 134.05, 129.79, 128.08, 125.82, 124.53, 122.14, 121.98, 121.11, 120.40, 84.15, 35.00, 34.89, 31.66, 30.89, 25.22.

### Synthesis of 2-Iodo-4-t-octylphenol

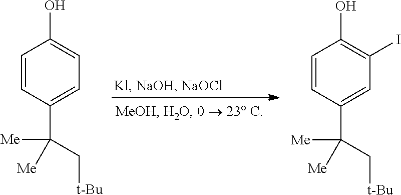 [SMILES: CC(C)(C)CC(C)(C)c1ccc(O)cc1 ; CC(C)(C)CC(C)(C)c1ccc(O)c(I)c1]

A clear colorless solution of the starting phenol (3.324 g, 16.110 mmol, 1.00 eq), KI (3.477 g, 20.943 mmol, 1.30 eq), and aqueous NaOH (21 mL, 20.943 mmol, 1.30 eq, 1 N) in methanol (100 mL) and water (50 mL) under nitrogen was placed in an ice bath and stirred vigorously for 1 hr, upon which precooled commercial aqueous bleach (26 mL, 20.943 mmol, 1.30 eq, 5.2% w/w) was added in a dropwise manner over 10 mins. The now pale opaque yellow mixture was stirred for 2 hrs at 0° C., the mixture was removed from the ice water bath, stirred at 23° C. for 3 hrs, solid NaH₂PO₄ (20 g) was added followed by a saturated aqueous mixture Na₂S₂O₃ (100 mL) to reduce residual iodine and water (100 mL), the mixture was stirred vigorously for 10 mins, diluted with CH₂Cl₂ (50 mL), the biphasic yellow mixture was poured into a separatory funnel, partitioned, organics were washed with aqueous Na₂S₂O₃ (2×50 mL), residual organics were extracted from the aqueous layer using CH₂Cl₂ (2×50 mL), combined, dried over solid Na₂SO₄, decanted, and concentrated onto celite, and purified via silica gel chromatography; hexanes—10% CH₂Cl₂ to afford the 2-iodo-4-t-octylphenol as a clear colorless amorphous foam (3.240 g, 9.340 mmol, 58%). NMR indicated pure product.

¹H NMR (500 MHz, Chloroform-d) δ 7.60 (d, J=2.3 Hz, 1H), 7.24 (dd, J=8.5, 2.3 Hz, 1H), 6.90 (dd, J=8.6, 0.5 Hz, 1H), 5.11 (s, 1H), 1.68 (s, 2H), 1.32 (s, 6H), 0.73 (s, 9H).

¹³C NMR (126 MHz, Chloroform-d) δ 152.34, 144.65, 135.66, 128.14, 114.23, 85.38, 56.87, 37.93, 32.35, 31.81, 31.55.

### Synthesis of Inventive Metal-Ligand Complex 1 (IMLC-1)

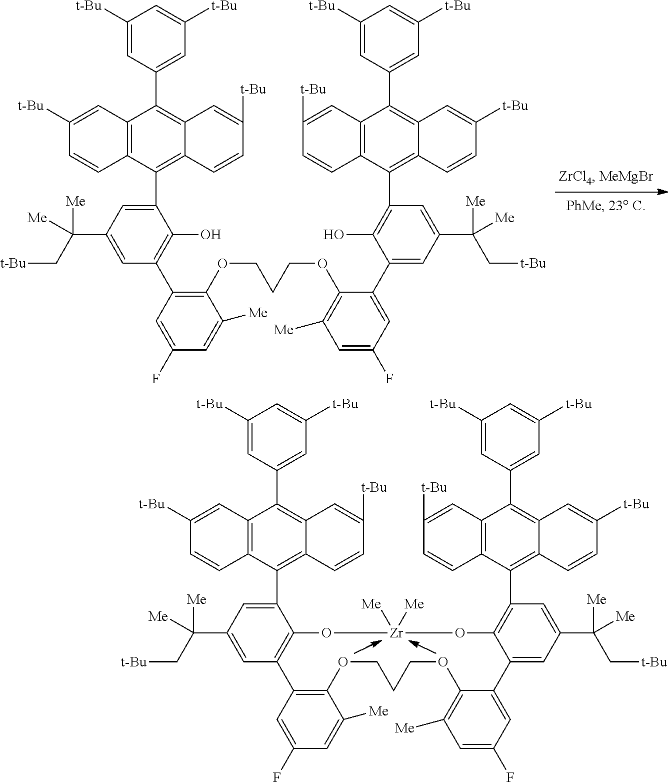

Prior to the experiment, Ligand 1 was azeotropically dried using toluene (4×10 mL). In a continuous purge, nitrogen filled glovebox, to a vigorously stirring (1000 rpm) suspension of ZrCl₄ (19.7 mg, 0.08441 mmol, 1.05 eq) at 23° C. in anhydrous deoxygenated toluene (10 mL) was added MeMgBr (0.12 mL, 0.3618 mmol, 4.50 eq, 3.0 M in Et₂O) was added via syringe in a quick dropwise manner. After stirring vigorously for 20 seconds, a solution of the bisbiphenyl phenol ligand (133.0 mg, 0.08039 mmol, 1.00 eq) in toluene (5 mL) was added in a quick dropwise manner to the now dark brown mixture. After stirring for 4 hrs, the black mixture was diluted with hexanes (10 mL), stirred vigorously for 2 mins, filtered through a 0.45 μm PTFE filter, rinsed with toluene/hexanes (3×5 mL, 1:1), the clear colorless solution was concentrated in-vacuo, suspended in anhydrous deoxygenated hexanes (3 mL), concentrated, re-suspended in hexanes (3 mL), and concentrated. The resultant white foam was suspended in toluene/hexanes (10 mL, 1:1), stirred (250 rpm) for 1 min, filtered through a 0.45 μm PTFE filter connected to a 0.20 μm PTFE filter, rinsed with toluene/hexanes (3×5 mL, 1:1), and concentrated to afford complex 1 as a tan, light brown powder (136.4 mg, 0.07690 mmol, 96%). NMR indicated product.

¹H NMR (500 MHz, Benzene-d₆) δ 8.69 (dd, J=9.2, 0.6 Hz, 2H), 8.25 (dd, J=2.1, 0.6 Hz, 2H), 8.16 (dd, J=9.3, 0.6 Hz, 2H), 7.93 (d, J=2.6 Hz, 2H), 7.89 (dd, J=2.0, 0.6 Hz, 2H), 7.73-7.72 (m, 2H), 7.69-7.65 (m, 4H), 7.57-7.51 (m, 4H), 7.20-7.15 (m, 2H), 7.11-7.08 (m, 2H), 6.53 (ddd, J=7.9, 3.2, 0.8 Hz, 2H), 3.55 (dt, J=10.1, 5.6 Hz, 2H), 3.13 (dt, J=10.1, 5.1 Hz, 2H), 1.69-1.62 (m, 4H), 1.47 (s, 18H), 1.39 (s, 18H), 1.36 (s, 6H), 1.33 (s, 18H), 1.33 (s, 6H), 1.30-1.24 (m, 2H), 1.10 (s, 18H), 0.91 (s, 6H), 0.88 (s, 18H), −1.29 (s, 6H).

¹⁹F NMR (470 MHz, Benzene-d₆) δ−116.01-−116.08 (m).

¹³C NMR (126 MHz, Benzene-d₆) δ 158.16 (d, J=218.3 Hz), 150.85, 150.47, 149.02 (d, J=2.7 Hz), 147.13, 146.02, 139.47, 139.24, 137.84, 136.30 (d, J=8.1 Hz), 134.89 (d, J=8.4 Hz), 133.96, 133.13, 130.91, 130.79, 128.99, 128.97, 128.86-128.80 (m), 128.72, 128.40, 126.50, 126.05, 125.29, 124.49, 123.38, 122.33, 121.21, 120.35, 117.55 (d, J=22.4 Hz), 115.46 (d, J=22.8 Hz), 73.96, 56.91, 41.22, 37.85, 37.79, 34.82, 34.72, 34.69, 34.53, 31.75, 31.45, 31.43, 30.78, 30.66, 30.50, 29.82, 22.73, 16.56, 13.98, 1.01.

### Synthesis of Inventive Metal-Ligand Complex 2 (IMLC-2)

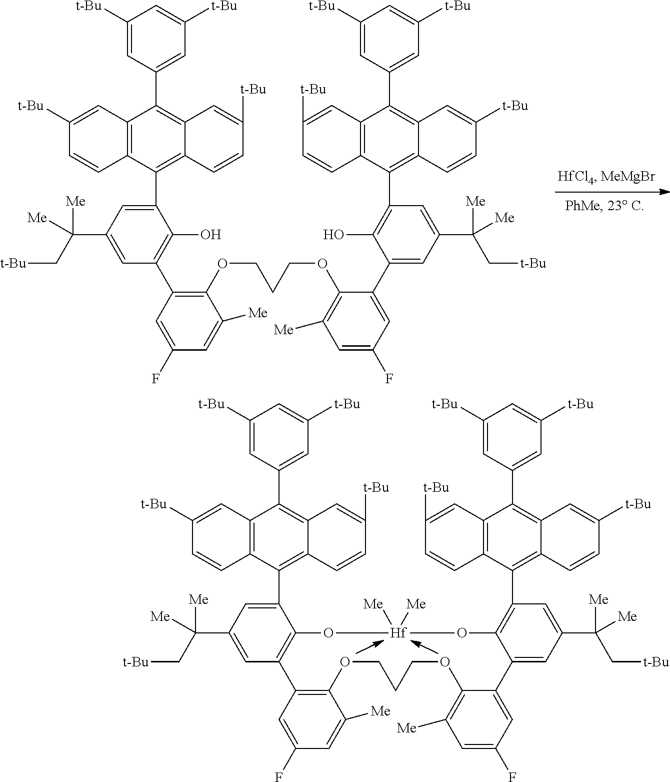

Prior to the experiment, Ligand 1 was azeotropically dried using toluene (4×10 mL). In a continuous purge, nitrogen filled glovebox, to a vigorously stirring (1000 rpm) suspension of HfCl₄ (23.2 mg, 0.07236 mmol, 1.05 eq) at 23° C. in anhydrous deoxygenated toluene (10 mL) was added MeMgBr (0.11 mL, 0.3101 mmol, 4.50 eq, 3.0 M in Et₂O) was added via syringe in a quick dropwise manner. After stirring vigorously for 20 seconds, a solution of the bisbiphenyl phenol ligand (114.0 mg, 0.06891 mmol, 1.00 eq) in toluene (5 mL) was added in a quick dropwise manner to the now dark brown mixture. After stirring for 4 hrs, the black mixture was diluted with hexanes (10 mL), stirred vigorously for 2 mins, filtered through a 0.45 μm PTFE filter, rinsed with toluene/hexanes (3×5 mL, 1:1), the clear colorless solution was concentrated in-vacuo, suspended in anhydrous deoxygenated hexanes (3 mL), concentrated, re-suspended in hexanes (3 mL), and concentrated. The resultant white foam was suspended in toluene/hexanes (10 mL, 1:1), stirred (250 rpm) for 1 min, filtered through a 0.45 μm PTFE filter connected to a 0.20 μm PTFE filter, rinsed with toluene/hexanes (3×5 mL, 1:1), and concentrated to afford the complex 2 as an off-white powder (121.8 mg, 0.06545 mmol, 95%). NMR indicated product.

¹H NMR (500 MHz, Benzene-d₆) δ 8.71 (dd, J=9.3, 0.6 Hz, 2H), 8.25 (dd, J=2.1, 0.6 Hz, 2H), 8.10 (dd, J=9.4, 0.6 Hz, 2H), 7.95 (d, J=2.6 Hz, 2H), 7.90 (dd, J=2.1, 0.7 Hz, 2H), 7.73 (t, J=1.8 Hz, 2H), 7.69-7.66 (m, 4H), 7.58-7.57 (m, 2H), 7.55 (d, J=2.6 Hz, 2H), 7.16 (dd, J=9.4, 3.2 Hz, 2H), 7.11-7.07 (m, 2H), 6.55 (ddd, J=7.8, 3.2, 0.8 Hz, 2H), 3.50 (dt, J=10.6, 5.5 Hz, 2H), 3.22 (dt, J=10.1, 5.1 Hz, 2H), 1.72-1.64 (m, 4H), 1.48-1.46 (m, 2H), 1.47 (s, 18H), 1.39 (s, 18H), 1.37 (s, 6H), 1.33 (s, 18H), 1.33 (s, 6H), 1.10 (s, 18H), 0.92 (s, 6H), 0.87 (s, 18H), −1.50 (s, 6H).

¹⁹F NMR (470 MHz, Benzene-d₆) δ-115.88-−115.95 (m).

¹³C NMR (126 MHz, Benzene-d₆) δ 160.08 (d, J=244.9 Hz), 157.78, 150.83, 150.49, 149.14-148.75 (m), 147.16, 146.01, 139.35, 139.25, 137.81, 136.47 (d, J=8.5 Hz), 135.05 (d, J=8.6 Hz), 134.03, 133.34, 130.89, 130.83, 129.01, 128.90, 128.77, 128.40, 128.21, 126.49, 126.10, 124.52, 123.34, 122.33, 121.19, 120.37, 117.60 (d, J=22.4 Hz), 115.51 (d, J=24.1 Hz), 74.28, 56.92, 47.15, 37.81, 34.83, 34.82, 34.69, 34.54, 32.37, 32.24, 32.14, 31.73, 31.44, 31.43, 30.79, 30.65, 30.49, 29.82, 16.54, 1.01.

### Synthesis of Inventive Metal-Ligand Complex 3 (IMLC-3)

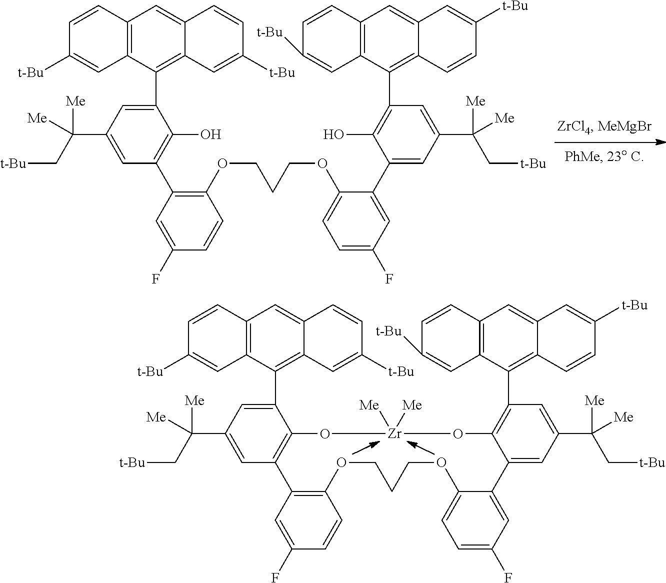

Prior to the experiment, Ligand 2 was azeotropically dried using toluene (4×10 mL). In a continuous purge, nitrogen filled glovebox, to a vigorously stirring (1000 rpm) suspension of ZrCl₄ (19.8 mg, 0.0850 mmol, 1.10 eq) at 23° C. in anhydrous deoxygenated toluene (20 mL) was added MeMgBr (0.12 mL, 0.3555 mmol, 4.60 eq, 3.0 M in Et₂O) was added via syringe in a quick dropwise manner. After stirring vigorously for 20 seconds, a solution of the bisbiphenyl phenol ligand (96.6 mg, 0.0773 mmol, 1.00 eq) in toluene (5 mL) was added in a quick dropwise manner to the now dark brown mixture. After stirring for 5 hrs, the black mixture was diluted with hexanes (5 mL), stirred vigorously for 2 mins, filtered through a 0.45 μm PTFE filter connected to a 0.20 μm PTFE filter, rinsed with toluene (3×5 mL, 1:1), the clear pale yellow solution was concentrated in-vacuo, suspended in anhydrous deoxygenated hexanes (3 mL), concentrated, re-suspended in hexanes (3 mL), and concentrated. The resultant amorphous foam was suspended in toluene (5 mL), filtered through a 0.45 μm PTFE filter connected to a 0.20 μm PTFE filter, rinsed with toluene (3×5 mL, 1:1), and the filtrate solution was concentrated to afford complex 3 as a white powder (84.0 mg, 0.0614 mmol, 79%). NMR indicated product.

¹H NMR (400 MHz, C₆D₆) δ 8.30 (s, 2H), 8.27-8.23 (m, 2H), 8.12-8.08 (m, 2H), 7.99 (d, J=9.0 Hz, 2H), 7.86 (d, J=8.9 Hz, 2H), 7.60 (d, J=2.5 Hz, 2H), 7.45 (td, J=4.2, 1.9 Hz, 4H), 7.40 (dd, J=8.9, 1.9 Hz, 2H), 7.29 (dd, J=9.1, 3.2 Hz, 2H), 6.54 (ddd, J=9.0, 7.4, 3.2 Hz, 2H), 4.47 (dd, J=8.9, 5.0 Hz, 2H), 3.76 (dt, J=10.5, 5.5 Hz, 2H), 3.25 (dt, J=10.3, 5.4 Hz, 2H), 1.62 (d, J=14.5 Hz, 2H), 1.53 (d, J=14.5 Hz, 2H), 1.36 (s, 6H), 1.32 (s, 6H), 1.28 (s, 18H), 1.17 (s, 18H), 1.17-1.11 (m, 2H), 0.78 (s, 18H), −1.42 (s, 6H). 19F NMR (376 MHz, C₆D₆) 6-115.72 (td, J=8.1, 5.2 Hz).

¹³C NMR (101 MHz, C₆D₆) δ 160.26 (d, J=245.3 Hz), 156.42, 151.01 (d, J=2.5 Hz), 147.54, 146.56, 139.81, 135.29 (d, J=8.0 Hz), 134.72, 131.89, 131.31, 130.70, 130.38, 129.95, 128.98, 125.30, 124.88, 124.04 (d, J=8.9 Hz), 123.58, 122.87, 120.67, 117.67 (d, J=23.1 Hz), 115.01 (d, J=22.7 Hz), 75.80, 56.68, 40.40, 37.85, 34.87, 34.72, 33.27, 32.28, 31.73, 30.94, 30.44, 30.36, 29.26.

### Preparation of Spray-Dried Supported Catalyst Systems:

### Production of Spray-Dried Supported Catalyst Systems

Prepare the spray-dried supported catalyst systems in a nitrogen-purged glove box as follows. Table 1 contains the amounts of the metal-ligand complex, fumed silica (Cabosil™ TS-610), 10 wt. % MAO solution in toluene, and toluene used to make each of the spray-dried supported catalysts of the Examples (EX) and Comparative Examples (CE).

In an oven-dried jar, slurry Cabosil™ TS-610 fumed silica in toluene until well dispersed. Add a 10% solution by weight of MAO in toluene. Stir the mixture magnetically for 15 minutes, then add the metal-ligand complex (IMLC-1, IMLC-2, IMLC-3) to the resulting slurry, and stir the mixture for 30-60 minutes. The mixture was then spray-dried using a Buchi Mini Spray Dryer B-290 with the following parameters to yield the dried sample: Set Temperature: 185° C., Outlet Temperature: 100° C. (min.), aspirator setting of 95 rotations per minute (rpm), and pump speed of 150 rpm.

TABLE 1
Quantities of reagents to make the spray-dried
supported catalyst systems of EX and CE

| Spray- | | Mass of | | | |
|---|---|---|---|---|---|
| Dried | | Metal- | Mass of | Mass of | |
| Supported | Metal- | Ligand | Fumed | 10% MAO | Mass of |
| Catalyst | Ligand | Complex | Silica | solution | Toluene |
| System | Complex | (g) | (g) | (g) | (g) |
| SD-Cat-1 | IMLC-1 | 0.090 | 0.598 | 5.25 | 37.5 |
| SD-Cat-2 | IMLC-1 | 0.035 | 0.525 | 4.27 | 37.5 |
| SD-Cat-3 | IMLC-1 | 0.021 | 0.650 | 5.13 | 37.5 |
| SD-Cat-4 | IMLC-2 | 0.100 | 0.623 | 5.53 | 37.5 |
| SD-Cat-5 | IMLC-2 | 0.034 | 0.485 | 3.96 | 37.5 |
| SD-Cat-6 | IMLC-2 | 0.022 | 0.650 | 5.12 | 37.5 |
| SD-Cat-7 | IMLC-2 | 0.019 | 1.140 | 8.84 | 37.5 |
| SD-Cat-8 | IMLC-3 | 0.046 | 0.905 | 7.27 | 37.5 |
| SD-Cat-9 | IMLC-3 | 0.021 | 0.845 | 6.64 | 37.5 |
| SD-Cat-10 | CMLC | 0.166 | 2.65 | 22.0 | 75.0 |

CMCL-HN-5 metal-ligand complex commercially available from Univation Technologies having the following structure:

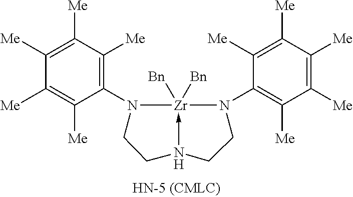

### Gas-Phase Batch Reactor Test:

Use the spray dried catalysts prepared above for ethylene/1-hexene copolymerizations conducted in the gas-phase in a 2L semi-batch autoclave polymerization reactor, as described herein. The individual run conditions, the catalyst productivity, and analytical data of the polymer produced in gas phase batch reactor experiments are tabulated and shown on Tables 2-13, below.

### Poly(ethylene-co-1-Hexene) Copolymer Resin Production

Gas-phase batch reactor catalyst testing procedure: The gas phase reactor employed is a 2-liter, stainless steel autoclave equipped with a mechanical agitator. For the experimental runs, the reactor was first dried, or “baked out,” for 1 hour by charging the reactor with 200 g of NaCl and heating at 100° C. under nitrogen for 30 minutes. After baking out the reactor, 5 g of spray-dried methylaluminoxane on fumed silica (SDMAO) was added as a scavenger under nitrogen pressure. After adding SDMAO, the reactor was sealed, and the components were stirred. The reactor was then charged with hydrogen and 1-hexene pressurized with ethylene as provided in each of Table 2 through Table 13, below. Once the system reached a steady state, the catalyst was charged into the reactor at 80° C. to start polymerization. The reactor temperature was then brought to the reaction temperature as seen in each of Table 2 though Table 13, and this temperature was maintained while keeping the ethylene, 1-hexene, and hydrogen feed ratios consistent, according to the respective Table, throughout the 1 hour run. At the end of the run, the reactor was cooled down, vented, and opened. The resulting product mixture was washed with water and methanol, then dried. Polymerization Activity (grams polymer/gram catalyst-hour) was determined as the ratio of polymer produced to the amount of catalyst added to the reactor.

### Tested Property Results

The semi-batch reactor results for the spray-dried supported catalyst systems, sd-Cat-1 thru sd-Cat-9, made from IMLC-1 thru IMLC-3, which contain a carbon bridge and substituted anthracenes as provided herein, are shown in Table 2 through Table 13. The productivity for most of the spray-dried supported catalysts in the semi-batch reactor test is higher than for the corresponding commercial comparative sd-CMLC (a commercial benchmark used for linear-low to high density applications), and the efficiency for sd-Cat-1 thru sd-Cat-9 is significantly higher than sd-CMLC under process relevant conditions (e.g., up to 18 times). Sd-Cat-8 and sd-Cat-9 also demonstrated higher comonomer incorporation capability than sd-CMLC, which may make the catalysts of the present disclosure suitable for producing bi- and multi-modal resins with additional degrees of freedom in the M_{w} of resin, in addition to designs that also incorporate increased comonomer at higher M_{w}, which may improve the end resin/product performance. Currently, this capability, under process relevant conditions in combination with high productivity and efficiency, is one that commercial benchmarks do not have.

In addition, Sd-Cat-8 and sd-Cat-9 produced poly(ethylene-co-1-hexene) copolymers having higher weight average molecular weight (M_{w}) as well as higher molecular weight of the peak maxima (Mp) and z weight average molecular weight (Mz) as compared to the copolymer made using sd-CMLC under the same reactor conditions (Table 8). The poly(ethylene-co-1-hexene) copolymers made exhibit advantageous polymer properties, which include MWD (Mw/Mn), while also having higher native molecular weights. These factors allow for a large range of possible copolymers made using sd-Cat-8 and sd-Cat-9, which are currently unattainable with sd-CMLC under process relevant conditions.

### Data

TABLE 2
Catalyst productivity, efficiency, and melt flow of
poly(ethylene-co-1-hexene) copolymers produced in the
gas phase batch reactor under high density conditions at 100° C.

| | | Cat. | | Productivity | | |
|---|---|---|---|---|---|---|
| Ex. | | Charge | Yield | (gPE/ | Efficiency | |
| No. | Catalyst | (mg) | (g) | gCat/hr) | (gPE/gM) | I₂, I₅, I₂₁ |
| EX-1 | sd-Cat-2 | 5.4 | 75 | 12,957 | 7,102,100 | 408, 432, |
| | | | | | | 645 |
| EX-2 | sd-Cat-3 | 10.2 | 28 | 6,149 | 6,740,800 | 367, 652, |
| | | | | | | 766 |
| EX-3 | sd-Cat-5 | 5.3 | 16 | 5,018 | 1,405,600 | 0.5, 2.2, 36 |
| EX-4 | sd-Cat-6 | 14.7 | 40 | 3,115 | 1,745,100 | 0.9, 3.8, 55 |
| EX-5 | sd-Cat-7 | 15.7 | 8 | 433 | 485,200 | 0.3, 1.6, 32 |
| EX-6 | sd-Cat-8 | 2.3 | 50 | 20,594 | 11,288,100 | No Flow |
| EX-7 | sd-Cat-9 | 4.4 | 49 | 11,129 | 12,200,200 | No Flow |
| CE-A | sd- | 10.2 | 58 | 5,431 | 1,215,000 | No Flow |
| | CMLC | | | | | |

*Batch reactor conditions: Temp. = 100° C., C6/C2 (molar ratio) = 0.004, H2/C2 (molar ratio) = 0.0068, ethylene partial pressure (C₂PP) = 230 psi, run time = 1 hr, catalyst injection temp. = 80° C. SCB = short chain branches; SCB/1000TC = short chain branches per 1000 total carbons.

TABLE 3
Catalyst productivity, efficiency, and melt flow of
poly(ethylene-co-1-hexene) copolymers produced in the gas phase
batch reactor under high density conditions at 100° C. and
H₂/C₂ = 0.002.

| | | Cat. | | Productivity | | |
|---|---|---|---|---|---|---|
| Ex. | | Charge | Yield | (gPE/ | Efficiency | |
| No. | Catalyst | (mg) | (g) | gCat/hr) | (gPE/gM) | I₂, I₅, I₂₁ |
| EX-8 | sd-Cat-1 | 2.3 | 163 | 69,113 | 18,039,300 | 161, 171, |
| | | | | | | 545 |
| EX-9 | sd-Cat-4 | 5.4 | 81 | 30,277 | 4,041,600 | NF, NF, |
| | | | | | | 1.68 |
| CE-B | sd- | 9.7 | 51 | 5,361 | 1,199,400 | No Flow |
| | CMLC | | | | | |

*Batch reactor conditions: Temp. = 100° C., C6/C2 (molar ratio) = 0.004, H2/C2 (molar ratio) = 0.002, C₂PP = 230 psi, run time = 1 hr, catalyst injection temp. = 80° C. SCB = short chain branches; SCB/1000TC = short chain branches per 1000 total carbons.

TABLE 4
Catalyst productivity, efficiency, and melt flow of
poly(ethylene-co-1-hexene) copolymers produced in the gas phase batch
reactor under high density conditions at 90° C. and C₆/C₂ = 0.005.

| | | | | Pro- | | |
|---|---|---|---|---|---|---|
| | | Cat. | | ductivity | | |
| Ex. | | Charge | Yield | (gPE/ | Efficiency | |
| No. | Catalyst | (mg) | (g) | gCat/hr) | (gPE/gM) | I₂, I₅, I₂₁ |
| EX-10 | sd-Cat-2 | 5.6 | 132 | 23,060 | 12,639,800 | 286, 290, 334 |
| EX-11 | sd-Cat-3 | 10.1 | 45 | 11,601 | 12,717,600 | 857, 752, 766 |
| EX-12 | sd-Cat-5 | 5.1 | 72 | 15,568 | 4,360,800 | 2.0, 7.5, 98 |
| EX-13 | sd-Cat-6 | 10.4 | 35 | 4,288 | 2,402,200 | 3.3, 11, 124 |
| EX-14 | Sd-Cat-7 | 15.9 | 15.3 | 578 | 647,600 | 0.04, 0.25, 9.2 |

*Batch reactor conditions: Temp. = 90° C., C6/C2 (molar ratio) = 0.005, H2/C2 (molar ratio) = 0.001, C₂PP = 230 psi, run time = 1 hr, catalyst injection temp. = 80° C. SCB = short chain branches: SCB/1000TC = short chain branches per 1000 total carbons.

TABLE 5
Catalyst productivity, efficiency, and melt flow of
poly(ethylene-co-1-hexene) copolymers produced in the gas phase
batch reactor under low density conditions at 90° C. and C₆/C₂ = 0.01.

| | | Cat. | | Productivity | | |
|---|---|---|---|---|---|---|
| Ex. | | Charge | Yield | (gPE/ | Efficiency | |
| No. | Catalyst | (mg) | (g) | gCat/hr) | (gPE/gM) | I₂, I₅, I₂₁ |
| EX-15 | sd-Cat-2 | 4.9 | 62 | 11,755 | 6,443,200 | 225, 839, |
| | | | | | | 835 |
| EX-16 | sd-Cat-3 | 10.4 | 67 | 6,211 | 6,808,800 | 857, 827, |
| | | | | | | 795 |
| EX-17 | sd-Cat-5 | 5.2 | 71 | 14,229 | 3,985,700 | 0.2, 1.0, 24 |
| EX-18 | sd-Cat-6 | 15.2 | 91 | 6,052 | 3,390,500 | 0.3, 1.6, 32 |

*Batch reactor conditions: Temp. = 90° C., C6/C2 (molar ratio) = 0.01, H2/C2 (molar ratio) = 0.001, C₂PP = 230 psi, run time = 1 hr, catalyst injection temp. = 80° C. SCB = short chain branches; SCB/1000TC = short chain branches per 1000 total carbons.

TABLE 6
Catalyst productivity, efficiency, and melt flow of
poly(ethylene-co-1-hexene) copolymers produced in the gas phase
batch reactor under low density
conditions at 90° C. and C₆/C₂ = 0.02.

| | | | | Pro- | | |
|---|---|---|---|---|---|---|
| | | Cat. | | ductivity | | |
| Ex. | | Charge | Yield | (gPE/ | Efficiency | |
| No. | Catalyst | (mg) | (g) | gCat/hr) | (gPE/gM) | I₂, I₅, I₂₁ |
| EX-19 | sd-Cat-1 | 4.9 | 42 | 21,386 | 5,582,000 | 857, 827, |
| | | | | | | 795 |
| EX-20 | sd-Cat-2 | 5.1 | 36 | 6,195 | 3,395,600 | 51, 831, |
| | | | | | | 826 |
| EX-21 | sd-Cat-3 | 5.6 | 25 | 2,783 | 3,050,900 | 357, 374, |
| | | | | | | 383 |
| EX-22 | sd-Cat-4 | 5.0 | 227 | 55,276 | 7,372,700 | NF, NF, 1.8 |
| EX-23 | sd-Cat-5 | 5.1 | 90 | 17,607 | 4,931,900 | NF, 0.1, 6.9 |
| EX-24 | sd-Cat-6 | 15.3 | 43 | 3,268 | 1,830,800 | 0.04, 0.2, |
| | | | | | | 9.2 |

*Batch reactor conditions: Temp. = 90° C., C6/C2 (molar ratio) = 0.02, H2/C2 (molar ratio) = 0.001, C₂PP = 230 psi, run time = 1 hr, catalyst injection temp. = 80° C. SCB = short chain branches; SCB/1000TC = short chain branches per 1000 total carbons.

TABLE 7
Catalyst productivity, efficiency, and melt flow of
poly(ethylene-co-1-hexene) copolymers produced in gas phase
batch reactor under low density conditions at 90° C. and C₆/C₂ = 0.03.

| | | Cat. | | Productivity | | |
|---|---|---|---|---|---|---|
| Ex. | | Charge | Yield | (gPE/ | Efficiency | |
| No. | Catalyst | (mg) | (g) | gCat/hr) | (gPE/gM) | I₂, I₅, I₂₁ |
| EX-25 | sd-Cat-2 | 5.6 | 25 | 3,462 | 1,897,600 | 59, 306, |
| | | | | | | 830 |
| EX-26 | sd-Cat-3 | 10.5 | 23 | 1,046 | 1,146,700 | 698, 767, |
| | | | | | | 826 |
| EX-27 | sd-Cat-5 | 5.0 | 60 | 12,198 | 3,416,800 | NF, 0.1, 6.7 |
| EX-28 | sd-Cat-6 | 15.5 | 54 | 3,626 | 2,031,400 | 0.04, 0.2, |
| | | | | | | 9.0 |

*Batch reactor conditions: Temp. = 90° C., C6/C2 (molar ratio) = 0.03, H2/C2 (molar ratio) = 0.001, C₂PP = 230 psi, run time = 1 hr, catalyst injection temp. = 80° C. SCB = short chain branches; SCB/1000TC = short chain branches per 1000 total carbons.

TABLE 8
GPC data for poly(ethylene-co-1-hexene) copolymers produced in gas phase batch reactor under
high density conditions at 100° C..

| Ex. | | Mw | Mn | PDI | (Mp) | Mz | Wt. % | SCB/ |
|---|---|---|---|---|---|---|---|---|
| No. | Cat. | (g/mol) | (g/mol) | (Mw/Mn) | (g/mol) | (g/mol) | C6 | 1000TC |
| EX-1 | sd-Cat-2 | 40,400 | 4,800 | 8.5 | 38,500 | 798,900 | 5.0 | 8.4 |
| EX-2 | sd-Cat-3 | 40,600 | 4,800 | 8.5 | 37,500 | 703,000 | 5.3 | 8.9 |
| EX-3 | sd-Cat-5 | 93,500 | 27,500 | 3.4 | 49,900 | 263,600 | 2.2 | 3.6 |
| EX-4 | sd-Cat-6 | 74,400 | 26,600 | 2.8 | 48,000 | 169,500 | 1.7 | 2.8 |
| EX-5 | sd-Cat-7 | 90,000 | 28,100 | 3.2 | 47,800 | 681,400 | 2.0 | 3.3 |
| EX-6 | sd-Cat-8 | 460,900 | 128,000 | 3.6 | 270,500 | 1,704,400 | 4.5 | 7.5 |
| EX-7 | sd-Cat-9 | 501,100 | 125,300 | 4.0 | 268,300 | 2,100,600 | 4.2 | 6.9 |
| CE-A | sd-CMLC | 261,300 | 65,300 | 4.0 | 141,200 | 1,048,000 | 2.2 | 3.7 |

*Batch reactor conditions: Temp. = 100° C., C6/C2 (molar ratio) = 0.004, H2/C2 (molar ratio) = 0.0068, C₂PP = 230 psi, run time = 1 hr, catalyst injection temp. = 80° C. SCB = short chain branches; SCB/1000TC = short chain branches per 1000 total carbons. PDI-Polydispersity Index.

TABLE 9
GPC data for poly(ethylene-co-1-hexene) copolymers produced in gas phase batch reactor under
high density conditions at 100° C. and H₂/C₂ = 0.002.

| Ex. | | Mw | Mn | PDI | Mp | Mz | Wt % | SCB/ |
|---|---|---|---|---|---|---|---|---|
| No. | Catalyst | (g/mol) | (g/mol) | (Mw/Mn) | (g/mol) | (g/mol) | C6 | 1000TC |
| EX-8 | sd-Cat-1 | 47,100 | 9,100 | 5.2 | 41,100 | 134,700 | 5.2 | 8.6 |
| EX-9 | sd-Cat-4 | 179,800 | 45,000 | 4.0 | 104,500 | 522,500 | 1.6 | 2.6 |
| CE-B | sd-CMLC | 497,900 | 99,600 | 5.0 | 266,700 | 1,900,500 | 2.4 | 3.9 |

*Batch reactor conditions: Temp. = 100° C., C6/C2 (molar ratio) = 0.004, H2/C2 (molar ratio) = 0.002, C₂PP = 230 psi, run time = 1 hr, catalyst injection temp. = 80° C. SCB = short chain branches; SCB/1000TC = short chain branches per 1000 total carbons. PDI-Polydispersity Index.

TABLE 10
GPC data for poly(ethylene-co-1-hexene) copolymers produced in gas phase batch reactor under
high density conditions at 90° C. and C₆/C₂ = 0.005.

| Ex. | | Mw | Mn | PDI | Mp | Mz | Wt % | SCB/ |
|---|---|---|---|---|---|---|---|---|
| No. | Catalyst | (g/mol) | (g/mol) | (Mw/Mn) | (g/mol) | (g/mol) | C6 | 1000TC |
| EX-10 | sd-Cat-2 | 38,900 | 5,700 | 6.8 | 38,300 | 720,400 | 6.0 | 10.0 |
| EX-11 | sd-Cat-3 | 36,600 | 6,500 | 5.6 | 39,200 | 105,100 | 6.8 | 11.3 |
| EX-12 | sd-Cat-5 | 69,200 | 24,700 | 2.8 | 46,200 | 174,600 | 2.7 | 4.5 |
| EX-13 | sd-Cat-6 | 64,700 | 24,000 | 2.7 | 45,800 | 181,200 | 2.5 | 4.2 |
| EX-14 | sd-Cat-7 | 86,900 | 27,200 | 3.2 | 46,000 | 681,400 | 2.7 | 4.5 |

*Batch reactor conditions: Temp. = 90° C., C6/C2 (molar ratio) = 0.005, H2/C2 (molar ratio) = 0.001, C₂PP = 230 psi, run time = 1 hr, catalyst injection temp. = 80° C. SCB = short chain branches; SCB/1000TC = short chain branches per 1000 total carbons. PDI-Polydispersity Index.

TABLE 11
GPC data for poly(ethylene-co-1-hexene) copolymers produced in gas phase batch reactor under
low density conditions at 90° C. and C₆/C₂ = 0.01.

| | | Mw | Mn | PDI | Mp | Mz | Wt % | SCB/ |
|---|---|---|---|---|---|---|---|---|
| Ex. No. | Catalyst | (g/mol) | (g/mol) | (Mw/Mn) | (g/mol) | (g/mol) | C6 | 1000TC |
| EX-15 | sd-Cat-2 | 31,200 | 4,800 | 6.5 | 33,900 | 1,205,200 | 7.7 | 12.9 |
| EX-16 | sd-Cat-3 | 28,700 | 4,700 | 6.1 | 33,900 | 408,500 | 8.0 | 13.3 |
| EX-17 | sd-Cat-5 | 86,100 | 25,300 | 3.4 | 50,000 | 216,700 | 4.1 | 6.8 |
| EX-18 | sd-Cat-6 | 82,700 | 25,800 | 3.2 | 49,300 | 205,800 | 4.2 | 7.0 |

*Batch reactor conditions: Temp. = 90° C., C6/C2 (molar ratio) = 0.01, H2/C2 (molar ratio) = 0.001, C₂PP = 230 psi, run time = 1 hr, catalyst injection temp. = 80° C. SCB = short chain branches; SCB/1000TC = short chain branches per 1000 total carbons. PDI-Polydispersity Index.

TABLE 12
GPC data for poly(ethylene-co-1-hexene) copolymers produced in gas phase batch reactor under
low density conditions at 90° C. and C₆/C₂ = 0.02.

| Ex. | | Mw | Mn | PDI | Mp | Mz | Wt % | SCB/ |
|---|---|---|---|---|---|---|---|---|
| No. | Catalyst | (g/mol) | (g/mol) | (Mw/Mn) | (g/mol) | (g/mol) | C6 | 1000TC |
| EX-19 | sd-Cat-1 | 24,700 | 5,500 | 4.5 | 9,230 | 74,200 | 9.9 | 16.6 |
| EX-20 | sd-Cat-2 | 28,000 | 3,800 | 7.4 | 3,800 | 2,680,400 | 10.7 | 17.9 |
| EX-21 | sd-Cat-3 | 30,000 | 3,600 | 8.4 | 3,600 | 3,043,700 | 11.0 | 18.3 |
| EX-22 | sd-Cat-4 | 183,000 | 42,600 | 4.3 | 106,000 | 548,800 | 5.3 | 8.9 |
| EX-23 | sd-Cat-5 | 108,900 | 27,900 | 3.9 | 63,300 | 266,800 | 6.2 | 10.4 |
| EX-24 | sd-Cat-6 | 103,100 | 27,900 | 3.7 | 60,400 | 243,000 | 6.1 | 10.1 |

*Batch reactor conditions: Temp. = 90° C., C6/C2 (molar ratio) = 0.02, H2/C2 (molar ratio) = 0.001, C₂PP = 230 psi, run time = 1 hr, catalyst injection temp. = 80° C. SCB = short chain branches; SCB/1000TC = short chain branches per 1000 total carbons. PDI-Polydispersity Index.

TABLE 13
GPC data for poly(ethylene-co-1-hexene) copolymers produced in gas phase batch reactor under
low density conditions at 90° C. and C₆/C₂ = 0.03.

| | | Mw | Mn | PDI | Mp | Mz | Wt % | SCB/ |
|---|---|---|---|---|---|---|---|---|
| Ex. No. | Catalyst | (g/mol) | (g/mol) | (Mw/Mn) | (g/mol) | (g/mol) | C6 | 1000TC |
| EX-25 | sd-Cat-2 | 31,200 | 3,100 | 10.0 | 3,700 | 4,071,200 | 12.9 | 21.5 |
| EX-26 | sd-Cat-3 | 26,800 | 3,000 | 8.9 | 3,700 | 3,159,200 | 12.9 | 21.5 |
| EX-27 | sd-Cat-5 | 104,500 | 26,800 | 3.9 | 65,900 | 250,000 | 7.8 | 13.0 |
| EX-28 | sd-Cat-6 | 104,500 | 28,200 | 3.7 | 66,400 | 234,400 | 8.1 | 13.5 |

*Batch reactor conditions: Temp. = 90° C., C6/C2 (molar ratio) = 0.03, H2/C2 (molar ratio) = 0.001, C₂PP = 230 psi, run time = 1 hr, catalyst injection temp. = 80° C. SCB = short chain branches; SCB/1000TC = short chain branches per 1000 total carbons. PDI - Polydispersity Index.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 g/cm³” is intended to mean “about 40 g/cm³.”

Notations used in the equations included herein refer to their standard meaning as understood in the field of mathematics. For example, “=” means equal to, “x” denotes the multiplication operation, “+” denotes the addition operation, “−” denotes the subtraction operation, “>” is a “greater than” sign, “<” is a “less than” sign, “and “/” denotes the division operation.

Every document cited herein, if any, including any cross-referenced or related patent or patent application and any patent or patent application to which this application claims priority or benefit thereof, is incorporated by reference in its entirety unless expressly excluded or otherwise limited. The citation of any document is not an admission that it is prior art with respect to any embodiment disclosed or claimed, or that it alone, or in any combination with any other reference or references, teaches, suggests, or discloses any such embodiment. Further, to the extent that any meaning or definition of a term in this document conflicts with any meaning or definition of the same term in a document incorporated by reference, the meaning or definition assigned to that term in this document shall govern.

1. A supported catalyst system comprising a metal-ligand complex disposed on one or more support materials, wherein the metal-ligand complex has a structure according to formula (I): 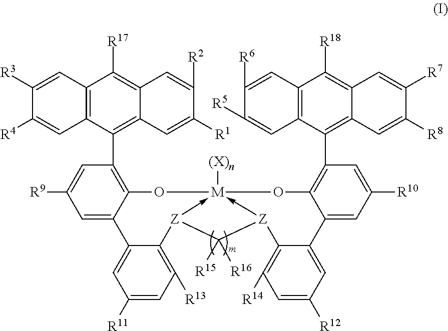
wherein:
M is titanium, zirconium, or hafnium;
n is 1, 2, or 3;
m is 1, 2, 3, 4, or 5;
each X is a monodentate ligand independently chosen from (C₁-C₅₀)hydrocarbyl, (C₁-C₅₀)heterohydrocarbyl, (C₆-C₅₀)aryl, (C₄-C₅₀)heteroaryl, halogen, —N(R^{N})₂, N(R^{N})COR^{C}, —OR, —OPh, —OAr and —H;
the metal-ligand complex is overall charge-neutral;
each Z is independently chosen from —O—, —S—, (C₆-C₅₀)aryl, (C₂-C₅₀)heteroaryl, N(C₁-C₅₀)hydrocarbyl, N(C₁-C₅₀)aryl, P(C₁-C₅₀)aryl and P(C₁-C₅₀)hydrocarbyl;
R¹-R⁸ are each independently (C₁-C₂₀)hydrocarbyl, (C₁-C₂₀)heterohydrocarbyl, and —H;
R⁹ and R¹⁰ are independently chosen from (C₁-C₂₀)hydrocarbyl, (C₁-C₂₀)heterohydrocarbyl and —H;
R¹¹ and R¹² are independently chosen from (C₁-C₂₀)hydrocarbyl, (C₁-C₂₀)heterohydrocarbyl, halogen and —H;
R¹³ and R¹⁴ are independently chosen from (C₁-C₂₀)hydrocarbyl, (C₁-C₂₀)heterohydrocarbyl and —H;
R¹⁵ and R¹⁶ are independently chosen from (C₁-C₂₀)hydrocarbyl, (C₁-C₂₀)heterohydrocarbyl and —H;
R¹⁷ and R¹⁸ are both: (C₁-C₂₀)hydrocarbyl, (C₁-C₂₀)heterohydrocarbyl, 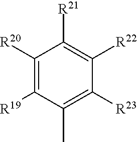
or —H, where R¹⁹⁻²³ are independently chosen from (C₁-C₂₀)hydrocarbyl, (C₁-C₂₀)heterohydrocarbyland —H; and
each R, R^{C} and R^{N} are independently chosen from —H, (C₁-C₅₀)hydrocarbyl, and (C₁-C₅₀)heterohydrocarbyl.

2. The supported catalyst system of claim 1, wherein R¹¹ and R¹² are fluorine (F).

3. The supported catalyst system of claim 1, wherein Z is —O—; or wherein m is 3; or wherein n is 2 and each X is methyl.

4. The supported catalyst system of claim 1, wherein R⁹ and R¹⁰ are each 1,1,-dimethyl-3,3-dimethylbutyl or t-octyl.

5. The supported catalyst system of claim 1, wherein R¹, R⁴, R⁵ and R⁸ are each independently (C₁-C₂₀)hydrocarbyl and R², R³, R⁶ and R⁷ are —H or R¹, R⁴, R⁵ and R⁸ are each —H and R², R³, R⁶ and R⁷ are each independently (C₁-C₂₀)hydrocarbyl; or wherein R¹, R⁴, R⁵ and R⁸ are each —H and R², R³, R⁶ and R⁷ are each tert-butyl; or wherein R¹, R⁴, R⁵ and R⁸ are each tert-butyl and R², R³, R⁶ and R⁷ are each —H; or wherein R¹⁷ and R¹⁸ are both 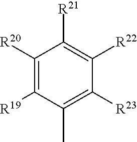
and R²⁰ and R²² are each tert-butyl and R¹⁹, R²¹ and
R²³ are each —H; or wherein R¹⁷ and R¹⁸ are both —H; or
wherein at least two R groups of R¹⁹⁻²³ are (C₁-C₂₀)hydrocarbyl.

6. The supported catalyst system of claim 1, wherein the one or more support materials comprise fumed silica; or wherein the supported catalyst system is a spray-dried supported catalyst system; or further including one or more activators; or further including an activator comprising methylalumoxane (MAO).

7. A method for producing a supported activated metal-ligand catalyst, the method comprising:
contacting one or more support materials and one or more activators with a metal-ligand complex in an inert hydrocarbon solvent to produce the supported activated metal-ligand catalyst, wherein the metal-ligand complex has a structure according to formula (Ib): 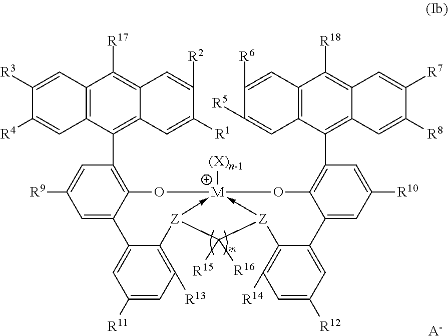
wherein:
A⁻ is an anion;
M is titanium, zirconium, or hafnium;
n is 1, 2, or 3;
m is 1, 2, 3, 4, or 5;
each X is a monodentate ligand independently chosen from (C₁-C₅₀)hydrocarbyl, (C₁-C₅₀)heterohydrocarbyl, (C₆-C₅₀)aryl, (C₄-C₅₀)heteroaryl, halogen, —N(R^{N})₂, N(R^{N})COR^{C}, —OR, —OPh, —OAr and —H;
each Z is independently chosen from —O—, —S—, (C₆-C₅₀)aryl, (C₂-C₅₀)heteroaryl, N(C₁-C₅₀)hydrocarbyl, N(C₁-C₅₀)aryl, P(C₁-C₅₀)aryl and P(C₁-C₅₀)hydrocarbyl;
R¹-R⁸ are each independently (C₁-C₂₀)hydrocarbyl, (C₁-C₂₀)heterohydrocarbyl and —H;
R⁹ and R¹⁰ are independently chosen from (C₁-C₂₀)hydrocarbyl, (C₁-C₂₀)heterohydrocarbyl and —H;
R¹¹ and R¹² are independently chosen from (C₁-C₂₀)hydrocarbyl, (C₁-C₂₀)heterohydrocarbyl, halogen and —H;
R¹³ and R¹⁴ are independently chosen from (C₁-C₂₀)hydrocarbyl, (C₁-C₂₀)heterohydrocarbyl and —H;
R¹⁵ and R¹⁶ are independently chosen from (C₁-C₂₀)hydrocarbyl, (C₁-C₂₀)heterohydrocarbyl and —H;
R¹⁷ and R¹⁸ are both: (C₁-C₂₀)hydrocarbyl, (C₁-C₂₀)heterohydrocarbyl, 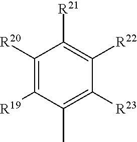
or —H, where R¹⁹⁻²³ are independently chosen from (C₁-C₂₀)hydrocarbyl, (C₁-C₂₀)heterohydrocarbyland —H; and
each R, R^{C} and R^{N} are independently chosen from —H, (C₁-C₅₀)hydrocarbyl, and (C₁-C₅₀)heterohydrocarbyl.

8. The method of claim 7, wherein the activator comprises methylalumoxane (MAO); or further including drying the supported activated metal-ligand catalyst, wherein drying includes spray drying the supported activated metal-ligand catalyst to produce particles of a spray-dried supported activated metal-ligand catalyst.

9. The method of claim 7, wherein the method further comprises:
disposing the one or more activators on the one or more support materials to produce a supported activator; and
contacting the supported activator with a solution of the metal-ligand complex in the inert hydrocarbon solvent; or wherein disposing the one or more activators on the one or more support materials comprises spray drying to produce a spray-dried supported activator.

10. The method of claim 7, wherein at least two R groups of R¹⁹⁻²³ are (C₁-C₂₀)hydrocarbyl.

11. A process for producing a polyethylene or a polyethylene copolymer resin in a gas phase polymerization reactor comprising:
contacting ethylene and, optionally, one or more (C₃-C₁₂)α-olefin comonomers with a supported activated metal-ligand catalyst in a gas-phase polymerization reactor, wherein the supported activated metal-ligand catalyst comprises a metal-ligand complex disposed on one or more support materials and one or more activators; wherein the metal-ligand complex has a structure according to formula (Ib): 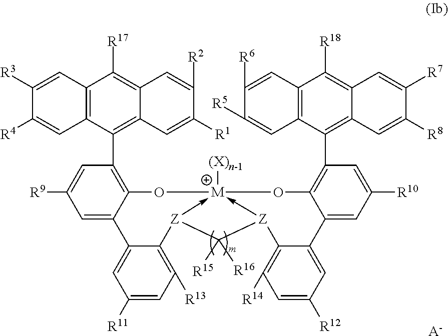
wherein:
A⁻ is an anion;
M is titanium, zirconium, or hafnium;
n is 1, 2, or 3;
m is 1, 2, 3, 4, or 5;
each X is a monodentate ligand independently chosen from (C₁-C₅₀)hydrocarbyl, (C₁-C₅₀)heterohydrocarbyl, (C₆-C₅₀)aryl, (C₄-C₅₀)heteroaryl, halogen, —N(R^{N})₂, N(R^{N})COR^{C}, —OR, —OPh, —OAr and —H;
each Z is independently chosen from —O—, —S—, (C₆-C₅₀)aryl, (C₂-C₅₀)heteroaryl, N(C₁-C₅₀)hydrocarbyl, N(C₁-C₅₀)aryl, P(C₁-C₅₀)aryl and P(C₁-C₅₀)hydrocarbyl;
R¹-R⁸ are each independently (C₁-C₂₀)hydrocarbyl, (C₁-C₂₀)heterohydrocarbyl and —H;
R⁹ and R¹⁰ are independently chosen from (C₁-C₂₀)hydrocarbyl, (C₁-C₂₀)heterohydrocarbyl and —H;
R¹¹ and R¹² are independently chosen from (C₁-C₂₀)hydrocarbyl, (C₁-C₂₀)heterohydrocarbyl, halogen and —H;
R¹³ and R¹⁴ are independently chosen from (C₁-C₂₀)hydrocarbyl, (C₁-C₂₀)heterohydrocarbyl and —H;
R¹⁵ and R¹⁶ are independently chosen from (C₁-C₂₀)hydrocarbyl, (C₁-C₂₀)heterohydrocarbyl and —H;
R¹⁷ and R¹⁸ are both: (C₁-C₂₀)hydrocarbyl, (C₁-C₂₀)heterohydrocarbyl, 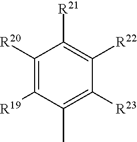
or —H, where R¹⁹⁻²³ are independently chosen from (C₁-C₂₀)hydrocarbyl, (C₁-C₂₀)heterohydrocarbyland —H; and
each R, R^{C} and R^{N} are independently chosen from —H, (C₁-C₅₀)hydrocarbyl, and (C₁-C₅₀)heterohydrocarbyl.

12. The process of claim 11, wherein the activator comprises methylalumoxane (MAO).

13. The process of claim 11, wherein the catalyst system is fed to the gas-phase polymerization reactor in neat form, as a solution, or as a slurry.

14. The process of claim 11, wherein the supported catalyst system is a spray dried supported catalyst system.

15. The process of claim 11, wherein at least two R groups of R¹⁹⁻²³ are (C₁-C₂₀)hydrocarbyl.
